(19) United States
(12) Patent Application Publication
(10) Pub. No.: US 2026/0321259 A1
(43) Pub. Date: Oct. 15, 2026

(54) SPEECH DRIVEN DOCUMENT PROCESSING WORKSTATION AND METHODS

(71) Applicant: OPEX Corporation, Moorestown, NJ (US)

(72) Inventors: Cyrille Raflin, Moorestown, NJ (US); Scott Mauer, Moorestown, NJ (US); Bill Kristich, Moorestown, NJ (US)

(21) Appl. No.: 19/646,084

(22) Filed: Apr. 13, 2026

Related U.S. Application Data
(60) Provisional application No. 63/788,206, filed on Apr. 14, 2025.

(51) Int. Cl. G10L 15/22; G06V 30/414

(52) U.S. Cl. CPC G10L 15/22; G06V 30/414

(57) ABSTRACT

A document processing workstation includes a scanner, a document transport configured to convey and feed documents to be scanned, a display, and a controller. The controller includes a processor and a memory containing instructions executable by the processor to perform speech analysis upon utterances made by an operator of the document processing workstation, to initiate acquisition of a set of image data corresponding to the image of a scanned document, to select, based on performed speech analysis, at least one document processing action based on information derived from an utterance, and to perform the at least one selected document processing action. In an embodiment, instructions are executable by the processor to identify a concatenated series of words or phrases for which a corresponding image processing action is required. The utterance may communicate a characterizing feature, a type classification, and/or an output destination for a scanned document.

### TECHNICAL FIELD

The present disclosure relates generally to the field of document processing and, more particularly, to the feeding and scanning of documents characterized by differences in document type, content, legibility, physical condition, vulnerability to handling damage, appearance attributes (e.g., color), other characteristics.

### BACKGROUND

A variety of systems have been proposed for receiving and digitizing groups of one or more documents with documents of a group being related to one another, for example, by their relevance to a transaction, a specific matter (e.g. an insurance claim), a person, or a business entity. Some specialized systems are capable of processing and scanning documents at rates in excess of ten thousand pages per hour. Such scanning rates, however, can only be achieved if the scanning is preceded by a lengthy and meticulous preparation process. The preparation required can encompass a large number of discrete manual tasks including, for example, inserting separator pages between groups of documents, different documents of a single group, and/or different document page types, removing small stick-on or stapled notes which would otherwise obfuscate content on the pages to which they are attached (and securing the removed notes to separate, full sized sheets), converting double sided originals to single sided pages, cutting folders into halves to capture information attached or written on them, and/or taping ripped or torn pages to backer sheets. Once the aforementioned manual preparation steps are complete, the resulting package is typically fed, as a stack, to a high-speed scanning system.

Another known document imaging and processing system is disclosed by Sullivan et al. in U.S. Pat. No. 11,973,908 entitled Document Imaging System and Method for Imaging Document and issued on Apr. 30, 2024 to the applicant of the present patent disclosure, OPEX Corporation. Sullivan et al. disclose a document processing workstation which is configured to simplify the process of acquiring document images despite variations in document type, quality and characteristics. Simplification is achieved, for example, by selectively routing documents along a non-bending scanning and discharge path (to thereby scan a wider variety of document types without damaging them) (e.g., fragile documents, x-rays, folders, damaged documents), so as to avoid many of the common preparation steps which would be required for higher speed batch scanning.

Although advances have been made in the processing of documents, improvements are needed to simplify document handling while increasing efficiency.

### SUMMARY OF THE DISCLOSURE

The inventors herein propose a document processing workstation which includes a scanner, a document transport configured to convey and feed documents to be scanned, a display, and a controller. The controller includes a processor and a memory containing instructions executable by the processor to perform speech analysis upon utterances made by an operator of the document processing workstation, to initiate acquisition of a set of image data corresponding to the image of a scanned document, to select, based on performed speech analysis, at least one document processing action based on information derived from an utterance, and to perform the at least one selected document processing action. As used herein, the term “utterance” refers to either an individual word, a string of related words forming a phrase, or a concatenated string of individual words and/or phrases. By way of illustrative examples, an utterance may communicate a characterizing feature, a type classification, and/or an output destination for a scanned document. In embodiments, speech analysis is performed to determine whether an association exists between an utterance and one or more discrete instructions executable, by the processor of the workstation controller, to perform corresponding image processing action(s). If such an associate exist, the controller operates the workstation to perform those actions.

In an embodiment, a method for processing documents comprises the steps of: placing a document onto a document transport of a document processing workstation; conveying the document along the document transport to a scanner of the document processing workstation; performing speech analysis upon an utterance made by an operator of the document processing workstation; scanning the document to acquire a set of image data corresponding to an image of the document; displaying, at the document processing workstation, an image of the document; and based on the performed speech analysis, selecting and performing at least one document processing action by storing supplemental information, determined by the speech analysis to be specified by the utterance, in association with the acquired set of image data, analyzing the acquired set of image data, responsive to a determination of document type obtained by the speech analysis, to obtain supplemental information and storing the obtained supplemental information in association with the acquired set of image data, determining that the utterance includes an instruction to perform an image altering action as the at least one document processing action and, responsive to determination of an image altering instruction, generating and storing a modified set of image data, wherein the displaying includes displaying a modified image at the workstation based on the modified set of image data, or determining that the utterance includes an instruction necessitating transformation of the acquired image data according to a predefined alternate set of one or more image processing rules that deviate from a default set of one or more rules predefined for documents possessing a predetermined attribute common to the document scanned, whereby a displayed document obtained by application of the alternate set of one or more image processing rules differs visually from a displayed document obtained by application of the default set of one or more image processing rules.

In a first aspect, the invention provides a method for processing documents using a document processing workstation. The method comprises placing a document onto a document transport and conveying the document to a scanner. Image data representing the document is acquired by scanning, and an image based on the acquired image data is displayed.

The method further comprises performing speech analysis on one or more utterances made by an operator and, based on the speech analysis, selecting and performing at least one document processing action.

In embodiments, the at least one document processing action comprises storing supplemental information derived from the one or more utterances in association with the image data. Such supplemental information may include metadata relating to document type, document attributes, or processing instructions specified by the operator.

In embodiments, the at least one document processing action comprises analyzing the image data to obtain supplemental information and storing the obtained supplemental information in association with the image data. The analysis may include optical character recognition applied to predefined regions of the document in response to identification of a document type.

In embodiments, the at least one document processing action comprises modifying the image data in response to an instruction identified in the one or more utterances. The modification may include rotation of the image data by a specified angle.

In embodiments, the at least one document processing action comprises transforming the image data according to an alternate set of image processing rules selected based on the one or more utterances, wherein the alternate set differs from a default set of image processing rules. For example, the alternate set may preserve multichromatic information in response to an utterance indicating that the document is a color document.

In embodiments, the speech analysis determines that an utterance specifies at least one of a document type, a document attribute, or a destination for the document.

In embodiments, the speech analysis identifies a concatenated sequence of words or phrases, each corresponding to a respective document processing action, and multiple document processing actions are performed sequentially based on the concatenated sequence.

In a second aspect, the invention provides a document processing workstation comprising a document transport configured to receive and convey a document, a scanner configured to acquire image data representing the document, a display configured to display an image based on the image data, and a controller.

The controller comprises a processor and a memory storing instructions which, when executed by the processor, cause the controller to perform speech analysis on one or more utterances made by an operator, control the scanner to acquire image data, select at least one document processing action based on the speech analysis, and perform the selected document processing action.

In embodiments, the controller is configured to store supplemental information derived from the one or more utterances in association with the image data.

In embodiments, the controller is configured to analyze the image data to obtain supplemental information and to store the obtained supplemental information.

In embodiments, the controller is configured to modify the image data in response to an instruction identified in the one or more utterances, including rotating the image data.

In embodiments, the controller is configured to transform the image data according to an alternate set of image processing rules selected based on the one or more utterances, wherein the alternate set differs from a default set of image processing rules.

In embodiments, the controller is configured to determine from the speech analysis that an utterance specifies a document type and to initiate optical character recognition based on the determined document type.

In embodiments, the controller is configured to identify a concatenated sequence of words or phrases within the one or more utterances and to execute multiple document processing actions corresponding to the concatenated sequence.

The invention provides improved efficiency and flexibility in document processing by enabling dynamic control of document handling and image processing operations based on speech analysis of one or more operator utterances. By allowing an operator to specify document processing actions through speech, the need for manual interaction with input devices is reduced, thereby decreasing operator workload and enabling more continuous document handling.

Furthermore, the identification of concatenated sequences of words or phrases within the one or more utterances enables multiple document processing actions to be specified and executed in a single interaction, which reduces processing latency and increases throughput of the document processing workstation. In addition, the selective application of alternate image processing rules, including modification of image orientation and preservation of multichromatic image data, improves the accuracy and usability of the resulting image data for subsequent processing. Overall, the invention enables real-time adaptation of document processing operations, resulting in more efficient and reliable document processing.

While the methods and system are described herein by way of example for several embodiments and illustrative drawings, those skilled in the art will recognize that inventive document processing workstations and methods incorporating inventive aspects of the present disclosure are not limited to the embodiments or drawings described. It should be understood that the drawings and descriptions thereof are not intended to limit embodiments to the particular form disclosed. Rather the intention is to cover all modifications, equivalents and alternatives falling within the spirit and scope of the systems and methods defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly the words “include”, “including”, and “includes” mean including, not limited to.

### BRIEF DESCRIPTION OF THE DRAWINGS

The foregoing summary and the following detailed description of embodiments consistent with the present disclosure will be best understood when read in conjunction with the appended drawings, in which the same reference numerals will be used throughout the drawings to refer to the same or like parts.

FIG. 1 is a block diagram depicting constituent elements of a single document processing workstation configured according to an illustrative embodiment consistent with the present disclosure;

FIG. 2 is an elevated perspective view of a document processing workstation dimensioned and arranged to selectively process either or both of documents dropped individually and documents dropped together as a packets, which may be used to implement the mechanical components of the illustrative embodiment of FIG. 1;

FIG. 3 is a state diagram depicting transitions between varies states of a document processing workstation according to embodiments consistent with the present disclosure;

FIG. 4 is an enlarged fragmentary view of an exemplary image entry feeder of the illustrative embodiment depicted in FIG. 2;

FIG. 5 is a side elevational view of the image entry feeder illustrated in FIG. 2;

FIG. 6 is a perspective view of a pivot arm of the image entry feeder illustrated in FIG. 4;

FIG. 7 is a plan view of the image entry feeder illustrated in FIG. 4 ;

FIG. 8 is a fragmentary plan view of a portion of the imaging station;

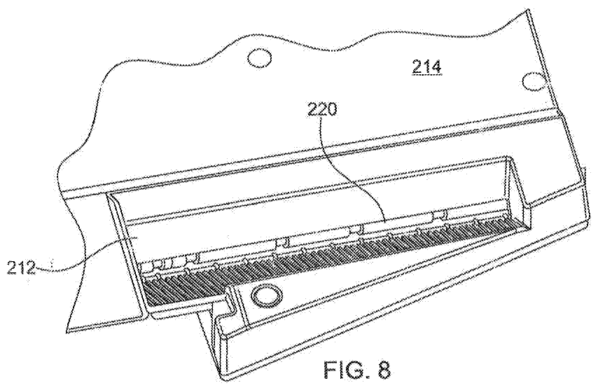

FIG. 9 is a schematic view of the document path of the device illustrated in FIG. 2 ;

FIG. 10 is a fragmentary view of the device illustrated in FIG. 2 ;

FIG. 11 is an enlarged fragmentary view of the sorter of the device illustrated in FIG. 2 ;

FIG. 12 is an enlarged fragmentary view of an alternate imaging sensor assembly of the device illustrated in FIG. 2 ;

FIG. 13 is a flow chart depicting a job or transaction set up process to be performed by a manager or administrator according to embodiments which may be implemented, for example, using a document processing workstation according to FIG. 1 or FIG. 2;

FIG. 14 is a flow chart depicting an exemplary process for operating a document processing work station utilizing speech analysis to identify concatenated words and/or phrases to dynamically implement appropriate sets of document handling and/or image processing rules according to embodiments consistent with the present disclosure, the steps of which may be performed using a document processing workstation according to FIG. 1 or FIG. 2.

### DETAILED DESCRIPTION

Embodiments of the present disclosure relate to document processing workstations able to convey documents to an imaging scanner, to acquire image data for the conveyed documents, to vary the way documents are handled during and/or after scanning and/or to obtain and, optionally, to modify, sets of image data acquired by scanning by application of dynamically selectable document processing rules. In embodiments, dynamic selectability—between pre-defined sets of one or more rules governing document handling and/or image processing—is achieved by performing speech analysis to recognize one or more word(s) and/or phrase(s) uttered by a workstation operator.

To this end, document processing workstations according to one or more embodiments consistent with the present disclosure are configured to perform speech analysis both on operator utterances made prior to scanning of a document (e.g., in time to select an alternate destination and/or conveyance path for the document than established by default), as well as subsequent to the scanning (allowing an operator to alter or affect the image data which would otherwise be obtained by application of a default set of image processing rules). At the completion of a scanning job, the acquired image data sets representing the plurality of documents comprising the job are output to an external data store (e.g., for subsequent retrieval and processing according to an external process).

By way of illustrative example, a default set of image processing rules may be applied to a full-color (i.e., multi-chromatic) set of image data that is acquired by scanning a document such as a multi-color invoice, claim form, medical record, or a photo. In some, but not all such cases, a grey scale or black and white (B&W) representation may be sufficient for the applicable custodians or consumers of the output set of image data. In an embodiment, a default set of image processing rules implements, without operator input, transformation of the set of image data captured by the imaging scanner from color to one of the other formats. In the aggregate, such an approach substantially reduces the amount of image data to be stored and transmitted. For a document such as a photo, however, an exemplary alternate set of image processing rules may be implemented if speech analysis determines that the word “color” is determined to be present in an utterance. In such a case, certain clean up and image alignment rules in common with the default set of rules may be performed, but the multichromatic components of the set of acquired image data are preserved. A document processing workstation according to one or more embodiments enables the operator need only utter the “color” command prior to dropping a document onto a feed conveyor of the workstation.

Alternatively, or in addition, an alternate set of image processing rules may be applied when a specific utterance is recognized to correspond to or necessitate a specific transformation of an acquired set of image data that overrides a default process. For example, a rule of the default set of image processing rules might require the orientation of the image, as represented in the stored image data, to be determined by the manner in which the source document was placed on the feed or drop conveyor. A rule of the alternate set of image processing rules, on the other hand, may be to rotate the image by a specified number of degrees when, for example, a phrase such as “rotate 90”, “rotate 180” or “rotate 270” has been uttered and determined through speech analysis.

Alternatively, or in addition, an alternate document processing rule may be applied when a recognized utterance is determined to correspond to or necessitate a specific document handling action. By way of illustration, a rule of a default set of document processing rules might specify that each document, of a first group of documents, be accumulated at a first destination bin by routing them away from the scanner along a folded discharge path that terminates at the first destination bin. Some documents of the group may be fragile, oversized, or possess some other attribute which make them unsuited for routing along the default routing path. In an embodiment, upon a determination that a single word such as “X-Ray”, “EKG” or “FRAGILE” was uttered by the operator prior to placement of a document onto the feed/drop conveyor, a non-standard scanning or handling procedure is invoked by the document processing workstation, whereby the applicable document is routed according to an alternate destination as, for example, one which does not necessitate travel along a folded, serpentine, or other curvilinear discharge path.

A document processing workstation configured according to any of the foregoing embodiments may further be configured to store supplemental information, determined by the speech analysis to be directly specified by an operator utterance, in association with a set of image data acquired by scanning and, optionally, subsequent image analysis. By way of illustrative example, an operator may observe before, during or after scanning a particular document, that the document is of poor quality which, customarily, might be expected to result in a “rescan” request by the party commissioning the applicable scanning project. Accordingly, the document workstation may be configured to recognize utterance of the phrase “poor quality original” and, responsively, to append a notation such as “PQO” to the set of image data acquired for that putatively deficient document.

By way of further illustrative example, a document processing workstation configured according to any of the foregoing embodiments may further be configured to respond to a recognized uttered phrase or word, by analyzing image data acquired for a document. Through such analysis techniques as optical character recognition (OCR), for example, known regions of a document can be quickly searched to identify information useful for subsequent business processes. As in the preceding embodiment, such supplemental information is stored in association with a set of image data acquired by scanning. By way of illustrative example, upon recognizing an utterance such as “claim form” or “stub” or “check”, such supplemental information as an invoice amount, check amount, or transaction number can be readily identified and stored to supplement the set of image data corresponding to the image.

In one or more embodiments, an association is established between respective words or phrases each corresponding to a discrete item of metadata to be stored in association with a transformed set of image data when a word or phrase is determined by speech analysis to be present in an operator utterance. Alternatively, or in addition, a prior association may be established between a recognized word or phrase uttered by the operator and a need to perform one or more image analysis sub-processes whereby specific supplemental information is determined to be present in a document to be or which has been scanned. By way of non-limiting example, a determination by speech analysis that an utterance contains an identification of a specific document type initiates an image analysis sub-process to perform optical character recognition at one or more specific locations or “fields” in a document and to store, in association with the transformed image data, the supplemental information obtained by the sub-process.

The inventors herein have determined that it is especially advantageous to train document processing workstation operators to concatenate commands or recognized expressions within utterances in order to minimize the number of times a set of image data must be transformed and displayed before processing of the next document can be started.

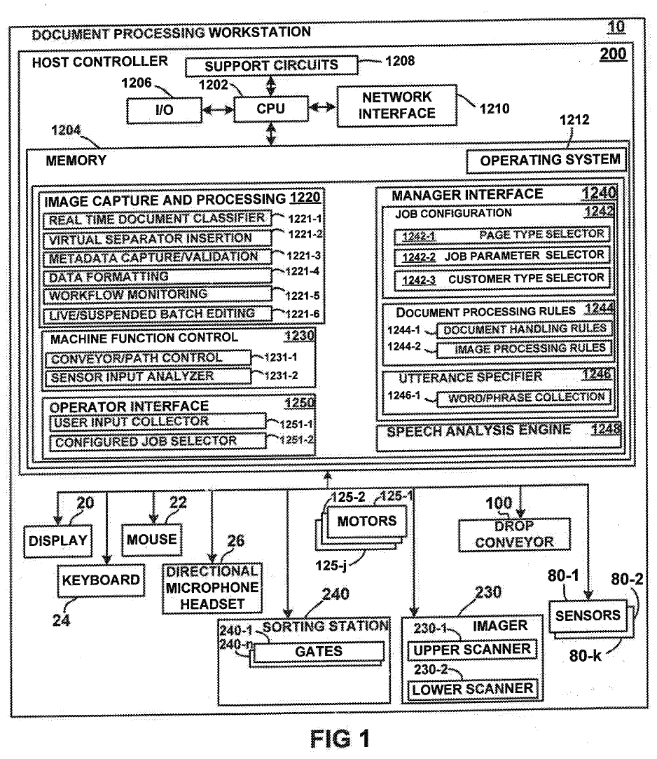

With initial reference to FIG. 1, there is shown a block diagram representation of the constituent functional elements of a single document processing workstation 10 configured according to an illustrative embodiment consistent with the present disclosure, it being understood that a typical installation may include many such workstations with each workstation as workstation 10 being attended by a corresponding operator.

The exemplary document processing station 10 of FIG. 1 includes a system (or host) controller 200, and a number of document processing and/or handling subsystems controlled by controller 200. As shown in FIG. 1, these subsystems include a drop conveyor 100 onto which documents are placed, a document imager 230 which receives and scans the documents in seriatim to acquire a respective set of image data for subsequent processing by workstation 10, and a document sortation station 240 which receives and sorts each scanned document to a destination of a plurality of destinations. In the exemplary embodiment of FIG. 1, document imager 230 includes an upper scanner 230-1 and a lower scanner 230-2 in order to accommodate scanning of both sides of a document. Sortation station 240 includes a plurality of motor-controlled gates indicated generally at 240-1 to 240-n, which are selectively operable to direct a scanned document to one of a plurality of destinations (not shown) which may, for example, be configured as bins, trays, chutes, a combination of any of the same, or any other structure dimensioned and arranged to accumulate and support documents as they are scanned during operation workstation 10.

With continuing reference to FIG. 1, it will be seen that controller 200 acquires sensory input from a plurality of sensors indicated generally at 80-1 to 80-k, which sensory input is used by controller 200 to operate one or more of motors, as motors 125-1 to 125-k, associated with each subsystem to advance each document along a conveyance path which begins at drop conveyor 100, passes through scanning station 230, and terminates at one of a plurality of bin or other destinations defined by sortation system 240. The overall path taken by a document processed by workstation 10, and the image processing operations performed on the image data acquired by imager 230, are respectively determined by the execution of instructions stored in memory 1204 by one or more processors coupled to memory 1204, as processor (CPU) 1202 of host controller 200.

The processor(s) of host controller 200 are coupled to system memory 1204 via an input/output (I/O) interface 1206. Host controller 200 further includes a network interface 1210 coupled to I/O interface 1206, and one or more peripheral input/output devices, such as display 20 (which may be a touchscreen display for data entry by an operator of workstation 10), a mouse 22 and a keyboard (e.g., to facilitate higher rate interactions with host controller by a system administrator). In various embodiments, any of the components may be utilized by the system to receive user input described above. In various embodiments, a user interface may be generated and displayed on display 20. In all embodiments consistent with the present disclosure, document processing workstation 10 further includes an operator headset 26 that is equipped with a direction microphone to prevent ambient noise sources and non-operator utterances from interfering with recognition, by speech analysis, of operator utterances needed to initiate and/or direct certain operations of workstation 10.

With continuing reference to FIG. 1, it will be seen that processor 1202 is configured to fetch and execute instructions, stored in memory 1204, to implement an operating system 1212, an image capture and processing module 1220, a machine function control module 1230, a manager interface module 1240, a speech analysis engine 1248, and an operator interface module 1250.

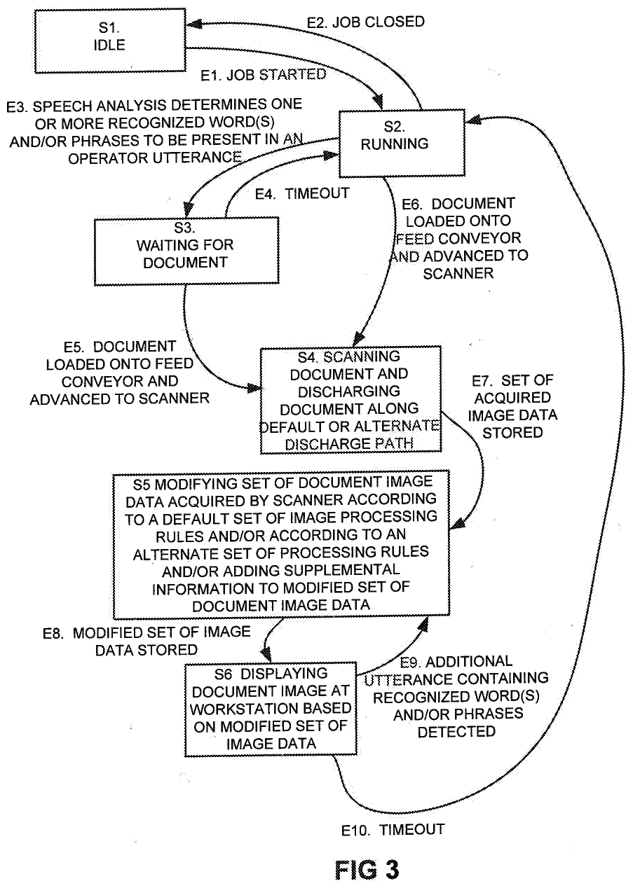

In one or more embodiments, image capture and processing module 1220 is responsive to user input to perform a number of image processing tasks that are determined by respective sets of image processing rules that are customizable for specific jobs, document types, and certain detectable document and/or document image characteristics. In some embodiments, image capture and processing module 1220 includes a real-time document classifier 1221-1 configured to analyze scanner-acquired image data to identify a document type and/or to select between multiple document type candidates based, in part, on the result of analysis of an operator utterance; a virtual separator inserter 1221-2 configured to insert a separator at, for example, the conclusion of a scan (thereby avoiding manual insertion of separator pages to mark transitions between transactions); a metadata capture/validation module 1221-3 configured to display supplemental information—collected by speech analysis of an operator's utterance or received as the output of an image analysis sub-process initiated by such speech analysis—and to append such supplemental information to acquired or transformed image data so that it is stored therewith and available for subsequent processing; transformer/formatter 1221-4 for transforming image data acquired by imager 230 by application of a default and/or alternate/supplemental set of image processing rules; a workflow monitor 1221-5 for tracking workstation processing subsystem states and state transitions as depicted in FIG. 3); and a live/suspended batch editing module 1221-6.

Machine function control module 1230 is directed to control, by controller 200, the operation of the electromechanical components of document processing workstation 10 such, for example, as the gates 240-1 to 240-n of sorting station 240, the drop conveyor 100 and other conveyors operated by one or more motors 125-1 to 1250-j as, for example, the conveyor which moves documents through imager 230. To this end, machine function control module includes a conveyor/path control module 1231-1. By way of representative example, module 1231-1 executes instructions stored in memory 1204 to actuate a first gate and one or more corresponding motor(s) to route a document to a first destination and thereby implement by default a first set of document handling rules in memory 1204 (e.g., when no pre-scan utterance indicative of (or necessitating) a need to divert a document-to-be-scanned to an alternate destination) or to actuate a second gate and corresponding motor(s) to route the document to a second destination and thereby implement a second set of document handling rules (e.g. when a pre-scan utterance is recognized by speech analysis to indicate or correspond to a need to divert a document-to-be-scanned to an alternate destination). In an embodiment, machine function control module further includes a sensor input analyzer 1231-2 which processes the input of sensors 80-1 to 80-k and initiates stopping and starting of motors 125-1 to 125-j, as well as the starting and stopping of other workstation processes.

According to embodiments consistent with the present invention, operator interface module 1250 includes a user input collector 1251-1 to, for example, authenticate an operator as being authorized and thereby provide customized levels of access to workstation functions matched to level of training an individual operator possesses. In embodiments, the information presented on display 20 is coordinated with the operating state of workstation 10, and analysis of speech collected by headset 26 is directed to the recognition of specific words and/or phrases against a focused pool of candidate words and/or phrases determined a priori to be relevant to the current workstation operating state. Operator interface module 1250 further includes a configured job selector 1251-2 by which one or more available jobs (or transactions) are presented on display 20 from which an operator may select, and the choice made by the operator is confirmed, determined, and implemented via interactions of the authenticated operator with the user interface components as the touchscreen of display 20, the mouse 22 (if present) and the keyboard 24 (if present).

According to embodiments consistent with the present invention, manager or administrator interface module 1240 enables a class of authenticated operator (via, for example, operator interface module 1250), to perform higher level functions and to customize business processes so as to minimize the level of training and specialized knowledge needed by typical operators of workstation 10. One duty performed by a manager is the configuration of jobs, for which job configuration module 1242 is optionally provided. In the exemplary embodiment depicted, job configuration module 1242 includes page type selector 1242-1, a job parameter selector 1242-2, and a customer type selector 123. Page type selector 1242-1 enables the manager, for a particular job to specify, among other things, a series of page types which apply to that job. By way of example, a job may require an operator of workstation 10 to scan a collection of medical records, with each collection corresponding to a unique patient. Such a collection might include such document types as practitioner visit summaries, investigations and results (e.g., lab results, x-rays, electrocardiograms), and prescription forms. By way of alternate example, an insurance claim transaction might include a claim form, medical records, photos, invoice forms, and checks.

Job parameter selector 1242-2 enables the manager to configure a set of image or document processing rules for specific jobs or transactions. For example, a job involving the scanning and processing of insurance claim transactions may be configured by selector 1242-2 by specifying a default set of rules for handing documents, as well as a set of optional image processing operations to be implemented based on the observations of the assigned operator. To conserve storage drive capacity, a manager may specify application of a default rule for such a job so that full color image data acquired by scanner 230 is transformed according to a default set of image processing rules whereby according to a first rule, an image cleanup is performed according to an appropriate algorithm and, according to a second rule, the resulting image data is converted to black and white or grey scale. However, that manager may determine that in some cases, faithful reproduction of multichromatic color (ie., more than is preserved by reducing an image to shades of gray) is needed to satisfy the party commissioning a scan project or to enable particular aspect of subsequent business process. In such cases, the manager may add “color” to the library of words or phrases contained in word/phrase collection 1246-1 of utterance specifier 1246, and start or add to an alternate set of image processing rules to the image processing rules module 1244-2 of document processing rules module 1244 specifying that color should be preserved during a transformation process which still applies the image cleanup rule(s).

Customer type selector 1242-3 of job configuration module 1242 enables the manager to begin the rule specification process with a “head start” by using a previously generated set of default and one or more sets of alternate image processing rules already contained in image processing rules module 1244-2 as a starting point for a particular job or transaction being created. In a similar manner, document handling rules module 1244-1 of document processing rules module 1244 enables a manager to create and/or modify rules governing how documents for specific jobs and/or transactions should be handled in a manner dynamically responsive to operator observations. So, for example, the operator might observe that an image is very fragile and, though within the scanning capabilities of workstation 10, not likely to survive, without damage, conveyance along a folded or acutely curvilinear path. In such cases, an utterance “fragile” added to word/phrase collection module 1246-1 of utterance specified 1246, and a gentle path routing/destination rule added document handling rules module 1244-1 ensures that the fragile document is directed to the appropriate destination.

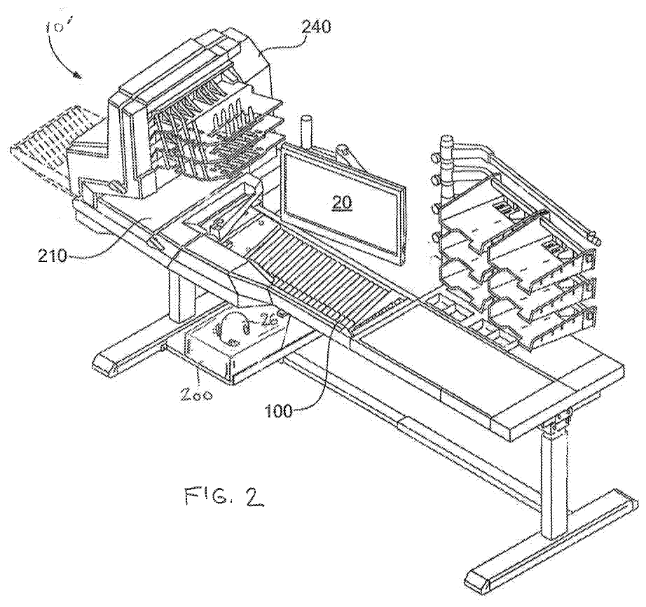

Referring now to FIG. 2, an exemplary embodiment of a document scanning workstation 10′,which incorporates elements functionally depicted in FIG. 1, is illustrated. Such a workstation is disclosed by Sullivan et al in commonly owned U.S. Pat. No. 11,973,908 which is expressly incorporated herein in its entirety. Workstation 10′ is configured to process documents whether they are dropped individually onto a drop conveyor 100 and fed in seriatim to the imaging scanner(s), as a small stack or packet comprising multiple documents, or as part of a workflow which includes both document feeding techniques. Drop conveyor 100 conveys the documents to imaging station 210. Imaging station 210 separates documents making up a packet (if required) and serially feeds the documents to an imaging scanner to obtain a respective set of image data for each documents. The documents so scanned are sorted into one or more output bins of sorting station 240.

### Drop Conveyor

In one or more embodiments consistent with the present disclosure, the drop conveyor 100 is configured to receive a variety of documents inclusive of standardized forms containing information at specified locations or fields in the document (e.g., insurance claim forms, invoices, pay stubs, checks, and the like), medical records (which may consist of X-rays, electrocardiograms, lab results, practitioner notes and observations, prescriptions, folders, photos, specialized envelopes, and the like), photos, and many others. Documents when dropped onto conveyor 100 are maintained in a generally horizontal or substantially horizontal orientation, and even when extracted singly from file folders or in a folded configuration, the documents require minimal (or no) preprocessing to prepare the documents for scanning at imaging station 210.

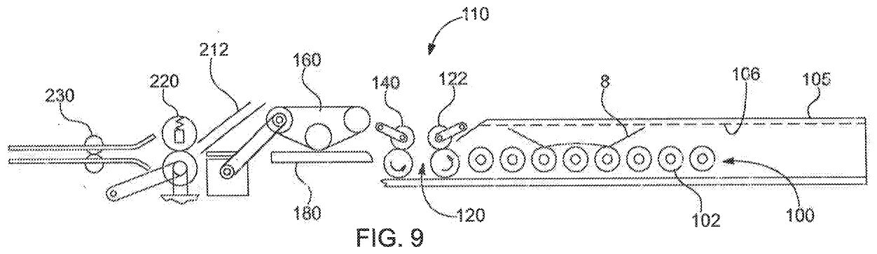

The operator need not be precise with the location and/or orientation that the documents are dropped onto on the conveyor. In the exemplary workstation 10′ of FIG. 2, drop conveyor 100 comprises a plurality of horizontally disposed cylindrical rollers which collectively define a document receiving roller bed. The rollers are driven by a belt which is turn driven by a drive motor controlled 125-1 by system controller 200 (each as exemplified by the embodiment depicted in FIG. 1). In some embodiments, rollers 102 may be parallel to each other and perpendicular to the direction of travel so that the documents move straight along the roller bed 100. However, in the embodiment of a document processing workstation depicted in FIG. 2, rollers 102 are skewed so that rollers 102 drive the documents forwardly along the roller bed and, at the same time, urge them laterally toward a justification rail 105 (FIG. 9). In this way, the skewed rollers 102 drive the documents against the rail 105 (FIG. 9) to edge-align or justify an edge of the documents against rail 105.

Each of rollers 102 comprises a plurality of grooves sized to receive O-rings. The O-rings have a higher coefficient of friction than the surface of the rollers, to provide an area of increased friction between the roller bed and the documents, thereby improving the justification of the documents. As mentioned previously, the document rests on the rollers. Therefore, as the rollers 102 rotate, the rollers move the documents forwardly.

In other embodiments consistent with the present disclosure, drop conveyor 100 may comprise a horizontal conveyor belt (not shown) which, in an embodiment, may be skewed toward rail 105 so that the belt justifies the documents against the rail as they are conveyed. In yet another embodiment, the drop conveyor may comprise a plurality of smaller conveyor belts onto which documents may be dropped.

In one or more embodiments consistent with the present disclosure, drop conveyor 100 is angled downwardly so that gravity acts upon the documents in a manner which urges the documents toward guide rail 105. In an embodiment, the document supporting surface collectively defined by the rollers 102 of drop conveyor 100 is angled at approximately five degrees, although the angle of declination may be higher, and in fact, even increased to the point where drop conveyor 100 is vertical rather than horizontal. Moreover, in embodiments consistent with the present disclosure, the imaging station 210 and sorting station 240 may be angled downwardly in a manner similar to drop conveyor 100.

### Document-Type Identification

As an operator processes documents, the operator may notice one or more characteristics, attributes in certain documents, or that the document itself is of a particular type. The presence (or absence) of such a characteristic or attribute in a document may necessitate implementation of an alternate set of document processing rules such as rules for pre and/or post scan handling of a document and/or for modifying or further modifying an already modified a set of image data acquired by scanning the document. To this end, a processor (as processor 1204 of controller 200 in FIG. 1) is configured to execute instructions stored in memory for implementing rules of a baseline set of one or more document handling rules and/or a baseline set of one or more image processing rules to be applied, for example, when the workstation operator determines that an attribute or characteristic is not present or that such an attribute or characteristic is present but need not be faithfully reproduced when applying an image transformation algorithm to clean up a document image (e.g., prior to forwarding the corresponding set of image data for external storage and/or retrieval). In the latter case, it is desirable to omit unimportant image characteristics from a final set of image data before outputting image data at the conclusion of a job. Conversely, the presence of certain characteristics in documents of a particular type or category may necessitate implementation of an alternate set of one or more document handling and/or image processing rules. Accordingly, in one or more embodiments, the processor of controller 200 is further configured to execute instructions stored in memory for implementing an alternate set of one or more rules for pre and/or post scan handling of the document and/or for modifying, further modifying an already modified set of image data acquired by scanning the document, and/or for preserving—in an acquired set of image data—data corresponding to characteristics or attributes which would be omitted were the applicable default set of one or more rules to be applied for that document.

As exemplified by the embodiments depicted in FIGS. 1 and 2, document processing workstations consistent with the present disclosure include an interface, such as a touch screen 20 and, optionally, a gesture based adjunct device (not shown), by which the operator may manually information prior to dropping a document onto conveyor 100. However, the inventors herein have determined that, unexpectedly, substantial and surprising processing efficiencies are achieved by applying speech recognition to utterances comprising a concatenates set of words and/or phrases. The need for the operator to take his or her eyes off the document handling work is, for example, greatly reduced and substantially enhances operator productivity. To that end, and in accordance with embodiments consistent with the present disclosure, the processor of controller 200 is configured to execute instructions stored in memory to perform speech analysis on operator utterances and, responsive to detecting such words and/or phrases, to implement a sequence of document processing sub-processes respectively associated, in memory, with the detected words and/or phrases. In embodiments, utterances of an operator are captured for analysis by a headset 26 (FIG. 2) equipped with a directional microphone so as to ensure that ambient noise generated by the moving parts of the workstation or other sources in proximity to the workstation does not affect the speech recognition results.

By way of illustrative example, a concatenated set of words or phrases comprising an utterance may include a first word identifying a document type, which then may be used to determine how the scanned image data for the document is to be processed. In that regard, system controller 200 may be configured to execute a one or more document processing sub-process operations associated in memory with a first word detected in an utterance and to execute one or more document processing sub-process operations associated in memory with a second word detected in the utterance. By recognizing and implementing a sequence of document processing steps by recognition of a concatenated series of pre-identified words or phrases, a variety of processing inputs are captured in a fast and efficient manner.

FIG. 3 is a state diagram depicting transitions between varies states of a document processing workstation according to embodiments consistent with the present disclosure, which implements document handling and/or imaging processing sub-processes dynamically responsive to detection of specific words and/or phrases in by machine operating state aware speech analysis of operator utterances. By operating state aware, it is contemplated by the inventors herein that at specific times during respective document handling, deposition, conveyance, image analysis, and sortation sub-processes, speech analysis can be efficiently performed to identify and act upon a relatively small set of concatenated words and phrases so that combinations of document processing tasks can be selected and initiated with high efficiency and accuracy.

Non-limiting examples include:

Color—The operator can, by merely uttering the word “color”, identify documents that should be scanned in color. In some jobs, the default scan may be black and white or gray scale. If the operator identifies a document for color scanning, the document is scanned in color rather than black and white or gray scale.

Color dropout—The operator can utter identify documents that should be scanned in color, but with a particular color dropped out from the scan. Responsive to a determination that an utterance identifies a color to be dropped from the scan, that color is dropped from the image data acquired by a scan.

Transaction boundary—Responsive to a determination that an utterance identifies a document as being the final document of a transaction, a virtual separator page may, by application of a rule applicable to such a document, be inserted to mark the boundary between a present group of documents comprising a current transaction, and future group of documents constituting a new transaction.

Automatic rotation—Responsive to determination that an utterance contains the phrase “rotate X degrees” where X is, for example, 90, 180, or 270, the image data captured by the image is transformed according to an automated image modification process so that a rotated image is displayed and stored, thereby facilitating conversion of an image from a portrait to a landscape orientation.

Metadata identification—The operator can by utterance of a word or phrase identifying a specific attribute or characteristic or, alternatively or in addition, identifying a document type, initiate generation and storage of certain supplemental information in association with the scanned image. For example, one word or phrase may identify the document as being a poor quality original (‘PQO”) while another word or phrase identifying a particular document conforming to a type standard (e. g, a check, invoice, stub, etc) may initiate execution, by the processor of controller 200, an image analysis process which identifies (e.g., by OCR) data at specific fields or locations of the document. Capturing such supplemental information and appending it to acquired image data facilitates routing of the scanned document to a particular person or office for specialized handling.

Differentiated Document Handling. Where a job may require processing of different document types that are virtually identical in size, such as a check and a money order, determination that an uttered word or phrase corresponds to a page-type determination may, by application of corresponding sets of document handling rules, be used to distinguish a money order from a check, so that the document images can be scanned appropriately and the documents sorted to separate locations. By way of additional example, a fragile document might be directed to an alternative discharge path which minimizes or avoids the imposition of bending and/or stretching forces during and after the scanning process, while an over-sized document might be diverted to an oversized bin.

This list of document features illustrates some of the different characteristics that can be identified by the operator. In addition, numerous other characteristics can be identified for different type of documents and different applications. Accordingly, the above list is not an exhaustive list of all of the features that can be used to initiate dynamically differentiated processing of documents responsive to recognized operator utterances.

### Image Entry Feeder

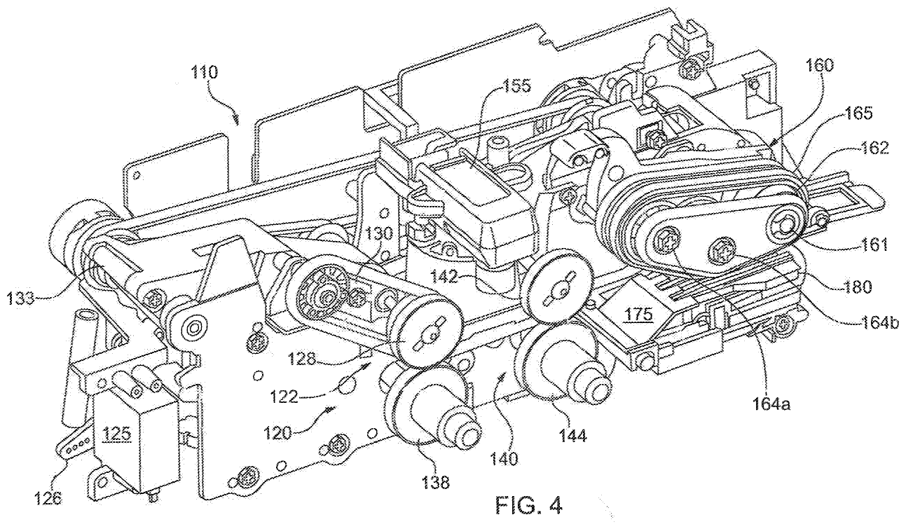

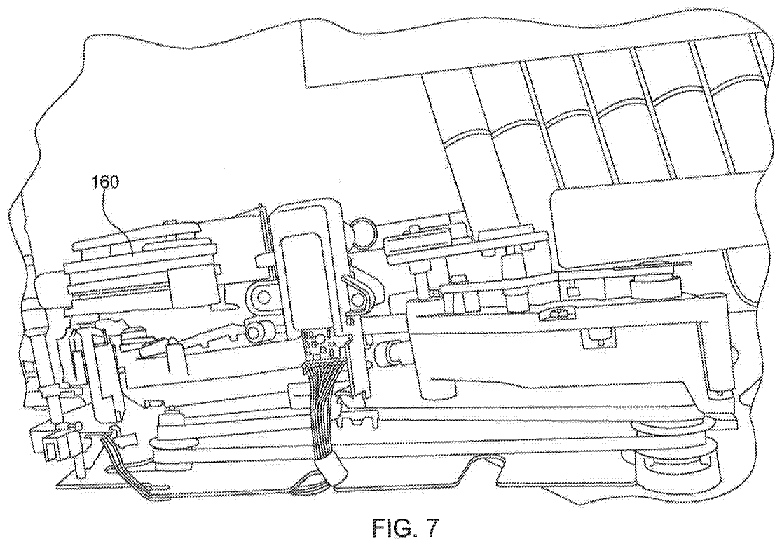

Referring to FIGS. 4-7, the details of the image entry feeder 110 will be described in greater detail. The image entry feeder is positioned adjacent the end of the drop conveyor 100, so that the drop feeder conveys the documents to the image entry feeder, which in turn feeds the documents to the imaging station 210. As the documents are conveyed to the image entry feeder 110, the documents are generally horizontally disposed, riding on top of the drop conveyor 100 and are edge-aligned against the justification rail 105.

The image entry feeder 110 is operable to serially feed documents from the drop conveyor 100 to the imaging station 210 so that the documents can be individually imaged. The image entry feeder 110 is operable to receive a number of different types of documents, including individual documents, envelopes, and packets of envelopes. In the following discussion, a packet of documents should be understood to mean a group of two or more documents that are in overlapping relation, as opposed to a number of documents that may be related, but which are conveyed serially to the image entry feeder. A packet may be as few as two documents, but may be substantially more. Specifically, as discussed further below, the system may be configured to process large packets of 50, 100 or even 200 documents. When a group of documents becomes large it is commonly referred to as a stack. However, for ease of discussion, it should be understood that a packet includes any group of two or more documents, including large packets commonly referred to as a stack.

When processing packets, the image entry feeder 110 separates and serially feeds each document in a packet to the imaging station 210. The image entry feeder 110 includes a pre-feeder assembly 120 and a feeder 160. The pre-feeder assembly 120 is configured to prepare packets for entry into the feeder 160, thereby reducing the likelihood of a jam occurring as a packet enters or is processed by the feeder.

The pre-feeder assembly 120 comprises a first pre-feeder 122 and a second pre-feeder 140 that control the packet of documents travelling from the drop conveyor 100 to the feeder 160. The first pre-feeder assembly 122 includes a pair of opposing rollers 128 and 138 that form a nip. An angled guide at the end of the justification rail 105 overhangs the conveyor 100 and directs the documents downwardly toward the nip of the first pre-feeder assembly 122. More specifically, for folded documents that were unfolded but remained creased or documents that are otherwise not flat, an upper edge of the documents tends to be spaced off the surface of the drop conveyor. The justification rail 105 has a lip overhanging the drop conveyor 100, so that this upper edge of the documents tends to be displaced under the lip of the justification rail as the conveyor tends to move the documents toward the justification rail. The angled guide interacts with the justification rail 105, so that the upper edge of the folded documents is flattened downwardly toward the conveyor so that the leading edge of the document can enter the nip of the first pre-feeder assembly rather than folding over.

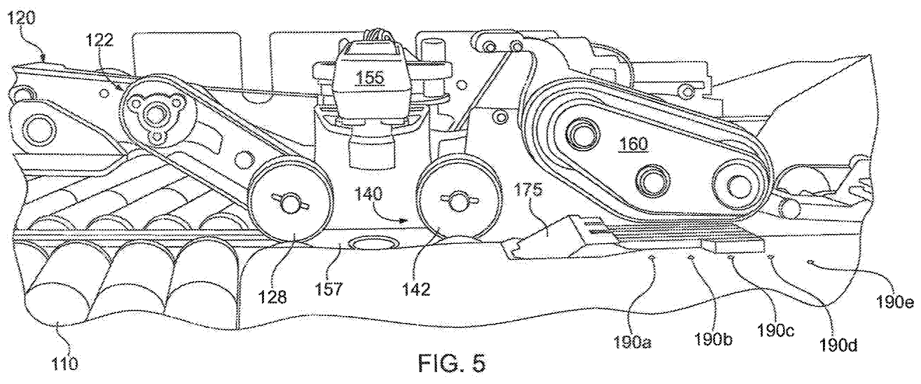

As mentioned above, the first pre-feeder assembly includes an upper roller 128 and a lower roller 138 that form a nip. The upper roller 128 is a drive roller, and the lower roller 138 is a driven roller. The upper roller 128 is mounted on a pivoting arm 130 that pivots about a pivot shaft at a pivot axis 132. A biasing element biases the pivot shaft to urge the upper roller 128 toward the lower roller 138. As documents enter the first pre-feeder assembly 122, the roller and pivoting arm pivot away from the lower roller against the bias of the biasing element to form a gap large enough to accommodate the document or packet of documents entering the first pre-feeder assembly. As the trailing end of the document or packet of documents exits the first pre-feeder assembly 122, the upper roller 128 pivots into engagement with the driven roller 138 until the subsequent document or packet enters the first pre-feeder assembly. Alternatively, if the packet includes numerous documents, an actuator may pivot the upper roller 128 upwardly (counter-clockwise from the perspective of FIG. 5) to reduce the likelihood that the first pre-feeder 122 pushes the top documents off the packet as the packet enters the first pre-feeder. The details of driving the pre-feeders upwardly are discussed further below.

The lower roller 130 of the first pre-feeder 122 is rotatably mounted on a fixed shaft, and may operate simply as an idler roller. In the present instance, the lower roller is coupled to the fixed shaft via a torque limiting device 132. A variety of torque limiting devices can be utilized, and in the present instance, the lower roller is connected with the shaft via a magnetic torque limiter.

From the first pre-feeder assembly 122, the documents enter the second pre-feeder assembly 140. The second pre-feeder also includes a driven upper roller 142 biased toward a driven lower roller 144 to form a nip.

As discussed above, the first and second pre-feeders 122, 140 comprise drive rollers that are biased toward opposing driven rollers. Although the upper drive rollers 128, 142 are pivotable to accommodate thick packets of documents, the upper rollers may tend to push the upper documents in the stack rearwardly (i.e. upstream toward the drop conveyor) as the packet enters the pre-feeders. To maintain the packets in a neat stack, it may be desirable to automatically lift the upper rollers 128, 142 of the pre-feeders prior to the packet entering the first pre-feeder 122.

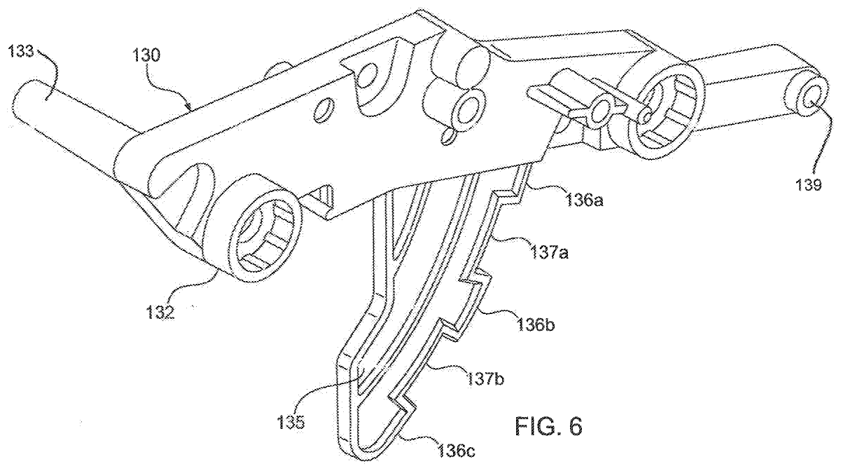

A variety of actuators may be used to drive the pre-feeder upper rollers 128, 142 upwardly, such as a linear drive element (e.g. a solenoid) or a rotary drive mechanism (a motor with a rotary output shaft). In the present instance, a motor 125-2 is operably linked with pivot arm 130 (FIG. 6) of first pre-feeder 122. Specifically, motor 125-2 is a first servo motor that drives an arm 126 (FIG. 6) clockwise or counter-clockwise (from the perspective of FIG. 4). In the present instance, the connecting linkage is a biasing element, such as a spring (not shown). The spring extends from arm 126 to a rod extending through post 133 that projects away from pivot arm 130. In this way, when the controller actuates the servo motor 125-2 to lift the arm 130 of the first pre-feeder 122, the servo motor 125-2 rotates arm 126 counter-clockwise, which in turn pulls down post 133, which in turn rotates pivot arm 130 counter-clockwise (from the perspective of FIGS. 4-5) thereby raising the prefeed upper rollers 128, 142. In this way, the upper (prefeed) roller 128 of the first pre-feeder 122 is raised so that the bottom edge of the upper roller is near or above the top surface of the packet of documents. The same actuator may be used to lift both the first and the second pre-feed arms. However, in the present instance, the second pre-feeder 140 is actuated independently by a separate actuator. Specifically, the second pre-feeder includes a second servo motor (not shown) and linkage configured similarly to the servo motor 125-2 and linkage described above.

The pre-feeder assembly 120 may be controlled so that the pre-feeder arms are pivoted upwardly before each document or packet of documents enters the pre-feeder assembly. However, lifting the pre-feed roller 128 and 142 is primarily beneficial when the packet is a thick packet of a significant number of documents. Accordingly, a thickness detector positioned along the drop conveyor 100 detects the thickness of documents as they are conveyed along the drop conveyor 100. If a packet of documents exceeds a threshold, the pre-feeder arms are lifted before the packet enters the pre-feeder assembly.

A variety of sensors can be used to measure the thickness of packets on the conveyor 100. In the present instance, one or more reflective sensors are mounted on the justification rail 105 at the front edge of the machine. If a sensor adjacent the end of the conveyor (adjacent the pre-feeder assembly 120) detects a thickness exceeding a threshold, the controller sends signals to the servo motors connected to the pre-feed arms 128, 142. In response to the signals, the servo motors as motor 125-2 drive the linkages to lift the arms.

Once the prefeed upper rollers 128, 142 are raised, the drop conveyor 100 continues to drive the packet forwardly into the pre-feeder assembly. A first sensor between the first and second pre-feeder is operable to detect the leading edge of the packet. For instance, the first sensor may be a beam break sensor, such as an emitter and receiver pair. If the first sensor detects the leading edge of the thick packet, the leading edge of the packet has entered the first pre-feeder 122. Therefore, the servo motor 125-2 de-actuates, pivoting arm 126 clockwise (from the perspective of FIGS. 4-5) which reduces the spring force pulling on post 133 of pivot arm 130. As a result, the first pre-feed arm pivots downwardly so that drive roller 128 contacts the top document in the packet. The second servo motor may also be de-actuated to allow the second pre-feed arm to lower at the same time. However, to limit the likelihood that the second pre-feeder lowers before the packet enters the pre-feeder, the second servo motor is de-actuated after the first servo motor 125-2. Specifically, a second sensor downstream from the first sensor may control de-actuation of the second servo motor. Specifically, the second sensor may be positioned closer to the second pre-feeder assembly 140 and when the leading edge of the packet is detected by the second sensor, the controller controls the second servo motor to lower the second pre-feeder arm 130 so that the upper wheel of the second pre-feeder lowers into contact with the top document in the packet of documents.

As described above, the first pre-feeder 122 and the second pre-feeder 140 cooperate to drive documents toward the feeder 160. The first and second pre-feeders may be controlled in tandem, however, in the present instance, the first pre-feeder 122 is controlled independently of the second pre-feeder. For example, a first clutch 195 may control engagement of the first pre-feeder. More specifically, a first drive belt 198 may drive the driven roller 128 of the first pre-feeder. The first clutch 195 is operable to engage and disengage the first drive belt with the drive 1. Similarly, a second clutch 197 may control engagement of the second pre-feeder. Specifically, a second drive belt 199 may drive the driven roller 142 of the second pre-feeder. The second clutch 197 is operable to engage and disengage the second drive belt with the drive motor. Additionally, rather than a single drive motor for both the first and second pre-feeders, the pre-feeder assembly 120 may include two separate drive motors to drive the drive rollers 128, 142. Further still, in the present instance, the drive motor that drives the first and second pre-feeders 122, 140, may also drive the feeder 160. If a single drive motor is used to drive both pre-feeders and the feeder, the system may include a third clutch that selectively engages and disengages the feeder with the drive motor.

As shown in FIGS. 4-5, a packet detector 155 is positioned between the first pre-feeder assembly 122 and the second pre-feeder assembly 140. The packet detector may be configured to provide indicia of the number of documents being conveyed from the first pre-feeder assembly 122 to the second pre-feeder assembly. In one manner, the thickness detector may determine the thickness of the document or packet of documents and then estimates the number of documents based on the assumed thickness for an individual document. However, in the present instance, the thickness detector 155 does not directly measure the thickness of the document or packet. Instead, the thickness detector 155 is an ultrasonic detector that uses ultrasound waves emitted from a transmitter and received by a receiver. Based on the signals received by the receiver, the number of transitions between sheets of papers can be determined to evaluate how many documents are in a stack. More specifically, the packet detector 155 detects whether the transaction in the pre-feeder is a packet of two or more documents as opposed to a single document.

### Feeder Station

The feeder 160 includes a plurality of feedbelts 165 spaced apart from one another across the width of the image entry feeder module 110. Although a single wide belt could be used, in the present instance, the feeder incorporates parallel belts mounted about a plurality of rollers. Specifically, in the present instance, the feeder 160 includes a drive roller 162 mounted on a drive shaft 161. The feedbelts 165 are also entrained about a pair of driven rollers 164 a, 164 b as shown in FIGS. 4-5. Roller 164 a, 164 b may be aligned with the drive roller 162 to create an upper belt run and a parallel lower belt run. However, in the present instance roller 164 b is offset from a line passing through the axis of drive roller 162 and driven roller 164 a. In this way, the lower run of feed belts 165 have a first portion angled downward and a second portion angled upwardly as shown in FIGS. 4-5. The rollers 162, 164 are rotatably mounted between a pair of mounting brackets. The front mounting bracket is a flat arm, whereas the rear mounting bracket includes an attached lifting arm for pivoting the feeder.

The feeder 160 is driven by drive shaft 161, and is also pivotable about the drive shaft. For instance, in FIGS. 4-5 the feeder 160 is pivoted downwardly into an operation position in which the feeder can feed documents. However, the feeder 160 may be pivoted upwardly about drive shaft 161 (clockwise from the perspective of FIG. 5) to allow removal of documents that may be jammed in the feeder.

A retard mechanism 180 is disposed below the feeder 160 opposing the feeder to selectively impede the entrance of documents into the feeder. The retard mechanism 180 selectively cooperates with the feed belts 165 to separate the documents in a packet. An angled ramp guides documents exiting the nip of the second pre-feeder assembly 140, and directs the documents toward the area between the feeder belts 165 and the retard assembly 180. The retard mechanism 180 includes a high friction retard pad 182.

### Control of Packet Advancement

If the packet detector 155 determines that the transaction is only a single document, the transaction does not need to be singulated by the feeder, so the document continues through the pre-feeder assembly 120 without being stopped. In contrast, if the packet detector determines that the transaction travelling from the first pre-feeder 122 to the second pre-feeder 140 has two or more documents then the packet is advanced to the feeder 160 and stopped at the feeder so that the feeder can singulate the documents in the packet.

As discussed further below, once the system determines that a transaction is a packet, the system may control the advancement of the packet based on the number of documents in the packet. More specifically, the distance that the packet advances before being stopped at the feeder may be controlled based on the thickness of the packet,

As discussed previously, in addition to the packet detector 155, a pre-feed sensor is also provided, which senses the leading edge of a document or packet as the document or packet is conveyed through the pre-feeder assembly 120. The pre-feed sensor may be any of a variety of sensors, and the functionality of the pre-feed sensor may be combined with the functionality of the packet detector 155. However, in the present instance, the pre-feed sensor is a separate sensor in the form of an infrared transmitter and receiver disposed between the first pre-feed assembly and the second pre-feed assembly. More specifically, the pre-feed sensor is mounted on the circuit board on which the ultra sound detector 155 is mounted, which is disposed between the first pre-feed assembly 122 and the second pre-feed assembly 140. Further still, a second pre-feed sensor is also provided. The first pre-feed sensor is disposed upstream from the packet detector 155 while the second pre-feed sensor is positioned along the document path downstream from the packet detector. Both pre-feed sensors are the same type of sensors and are located along the paper path so that the system can track the leading edge of the packet as the packet exits the first pre-feeder 122 and enters the second pre-feeder 140.

From the second pre-feeder assembly 124, the documents enter the feeder 160. Specifically, a feed slot is formed between the feeder 160 and a retard assembly 180 below the feeder. An angled ramp 175 guides documents exiting the nip of the second pre-feeder assembly 140, and directs the documents toward the area between the feeder belts 165 and the retard assembly 180. As discussed further below, the angled ramp 175 and the feeder 160 combine to form a convexly angled or tapered entrance slot to the feeder. In this way, the height of the entrance slot (i.e. the distance between the ramp 175 and the feed belts 165) tapers down as the document path progresses downstream through the entrance to the feeder until the height of the entrance slot reaches a minimum about midway along the length of the feeder.

If a packet of documents is fed through the pre-feeder assembly 120, the feeder operates to singulate the documents in the packet so that each document is serially fed into the imaging station 210. If instead of a packet, a single document is fed through the pre-feeder assembly 120, the single document simply passes through the pre-feeder and is fed by the feeder 160 to the imaging station 210.

By incorporating a tapered entrance slot, the feeder can accommodate a wider variety of packet thickness without having to pivot the feeder to create a feed slot thick enough to accommodate packets having numerous documents while at the same time being able to control single document transactions and/or transactions having only a few documents.

Specifically, the system controls the advancement of packets through the pre-feeder 120 based on the thickness of the packet. In particular, the distance a packet is advanced into the entry slot of the feeder is inversely related to the thickness of the packet. For instance, a packet of 100 sheets has a packet thickness of roughly 0.400″ whereas a packet of 10 sheets has a packet thickness of roughly 0.040″″. Since the entrance slots tapers, the packet of 10 sheets can advance farther into the feed slot until the upper sheet contacts the feed belts, which form the upper surface of the entry slot. In contrast, the packet of 100 documents will not have to advance as far into the entry slot before the upper sheet in the packet contacts the feed belt.

Accordingly, in order to control the advancement of the packets, the system detects the thickness of the stack and monitors the advancement of the packet to stop the stack at the appropriate location relative to the feeder. A variety of sensors or detectors can be used to detect the thickness of the packet. However, in the present instance the system determines the thickness of the packet based on the displacement of the pivot arm of the first pre-feeder 122. Specifically, a pair of optical sensors is provided, with each having an emitter and a corresponding receiver. The optical sensors are positioned next to one another with the first being positioned vertically above the second pair. The optical sensors detect the movement of an indicator attached to the upper pivot arm 130 of the first pre-feeder. The optical sensors straddle the indicator to monitor the movement of the thickness indicator as the upper pivot arm pivots to accommodate the thickness of the packet. Since the displacement of the pivot arm 130 is proportional to the thickness of the stack, monitoring the displacement of the pivot arm can roughly determine the thickness of the packet.

Referring to FIG. 6, the details of the thickness indicator 135 are illustrated. The thickness indicator 135 comprises a series of teeth 136 separated by notches 137. A single optical sensor could be used to detect the movement of the thickness indicator 135. Specifically, in the instance of an infrared optical sensor having an emitter and a corresponding receiver, the emitter is positioned on a first side of the thickness indicator 135 while the receiver is positioned on the other side of the thickness indicator so that the thickness indicator passes between the emitter and the receiver (i.e., the optical sensor straddles the thickness indicator). The sensor is positioned so that the sensor is blocked when a tooth 136 is aligned with the sensor and so that the sensor is unblocked when a notch 137 is aligned with the sensor. In this way, the sensor detects the number of translations from blocked to unblocked and from unblocked to blocked as the pivot arm 130 pivots to accommodate the thickness of the packets—as previously mentioned, the thicker the packet, the further the pivot arm pivots to accommodate the packet.

Although a single sensor can be used to detect the packet thickness, in the present instance a pair of optical sensor are aligned in a stacked formation. By way of example, if upper tooth 136 a blocks both optical sensors when no packet is in the first pre-feeder 122, the pivot arm 130 will pivot upwardly (counter-clockwise) as the packet pushes the pivot arm upwardly. As the pivot arm 130 pivots, the lower sensor will first detect a transition from blocked to unblocked as when the upper edge of the first notch aligns with the lower sensor. As the pivot arm continues to pivot upwardly, the upper sensor will detect the transition from the first tooth 136 a to the first notch 137 a. This detection of transitions will continue for the two sensors as the pivot arm pivots upwardly so that the sensors detect the transition from the first notch 137 a to the second tooth 136 b then to the second notch 137 b until sensing the transition from the second notch 137 b to the third tooth 136 c. In this way, the thickness of the packet is related to the number of transitions detected by each of the optical sensors.

Conversely, as the feeder 160 singulates the documents in the packet, the thickness of the packet will reduce, thereby causing the pivot arm 130 to pivot downwardly, which in turn will cause the optical sensors to detect the opposite transitions from when the pivot arm move upward to accommodate the thickness of the packet. Accordingly, the system is operable to continuously monitor a characteristic indicative of the thickness of the packet while a portion of the packet is in the first pre-feeder.

As discussed previously, when processing a packet, particularly a thick packet, it may be desirable to pivot the pivot arms, as pivot arm 130, upwardly so that the front edge of the packet does not collide with the corresponding drive roller of driver rollers 128, 142, which could disrupt the packet of documents and cause the packet to shingle or unstuck prematurely. If the arms are raised before receiving the packet, the packet thickness described above can still be used. Specifically, when the pivot arm of the first pre-feeder is raised up, the thickness indicator will be pivoted upwardly so that the sensors will detects the pivoting of the pivot arm similar to that described above when the packet pushes the pivot arm upwardly. After the arms are lifted and the packet enters the pre-feeder 120, the servo 125 reverses direction thereby driving arm 125 clockwise. Raising arm 125 relaxes the spring thereby decreasing the biasing force that lifts the pre-feed arm 130 (i.e. the tension force between arm 126 and post 133 of arm 130). In response, the pre-feed arm 130 pivots downwardly toward the stack. Specifically, in the present instance, a biasing element is disposed between the frame of the pre-feeder and the end 139 of arm 130 opposite post 133. The biasing element biases the pre-feeder arm 130 against counter-clockwise rotation, so that the biasing element biases the first pre-feed roller 128 downwardly toward the opposing roller 138. After the pivots arm is released, the sensors will detect the downward pivoting of the arm 130 similar to when the arm pivots downward when the packet height is reduced as the feeder singulates the documents. Accordingly, regardless of whether the packet pushes the pivot arms up or whether the system drives the pivots arms up and then releases them, the thickness detector made up of the thickness indicator and the optical sensor(s) can continuously detect and monitor the packet thickness in the first pre-feeder. As the height of the packet reduces, the servo motor 125 raise arm 126 to decrease the bias force that tends to lift the arm 130. In this way, as the documents are fed from the packet, the system controls the displacement of arm 125 to balance the tension force lifting roller 128 away from the top of the packet and the tension force pulling the roller 128 down toward the top of the packet to maintain the force of roller 128 against the packet at a substantially constant rate.

The system also tracks the leading edge of the packet as the packet advances through the pre-feeder assembly 120 toward the feeder 160. For instance, the system may include a series of sensor 190 a, 190 b, 190 c, 190 d, 190 e, 190 f aligned along the document path adjacent the feeder 160. As the packet advances toward and into the feeder the leading edge of the packet sequentially blocks the sensors 190 a-f. For instance, as the packet advances toward the feeder, the leading edge of the packet first blocks sensor 190 a. If the packet is advanced further, the leading edge of the packet blocks sensor 190 b. This continues until the packet is stopped at the feeder to stage the packet for singulation.

Accordingly, after determining the thickness of the packet, the pre-feeder assembly 120 advances the packet toward the feeder. The distance that the packet is advanced toward the feeder correlates with the thickness determined for the packet. For instance, if the system determines that the packet has a thickness similar to a packet of 100 documents, the packet may be advanced until the leading edge of the packet covers feeder sensor 190 a, at which point the packet is stopped to stage the packet at the feeder. If the system detects a packet having a lower thickness, such as a thickness similar to a packet of 50 documents, the packet may be advanced farther into the feeder, such as until the leading edge of the packet covers sensor 190 c, at which point the packet is stopped to stage the packet at the feeder for singulation. Additionally, after the packet is staged and the feeder begins singulating the packet, the height of the packet will reduce. When the detected thickness of the packet reduces below a threshold, the packet may be advanced further into the feeder. For instance, turning to the example described above, once the packet of 100 documents is reduced down to 50 documents, the packet may be advanced until the leading edge of the packet covers sensor 190 c.

In the foregoing discussion, the advancement of the packet through the pre-feeder assembly 120 is controlled based on the detected thickness of the packet as well as the position of the leading edge of the packet. However, it should be understood that other factors may also affect the advancement of the packet through the pre-feeder assembly. For instance, the system tracks the trailing edge of a first packet and the leading edge of the following packet. In order to ensure a proper gap between successive packets, the advancement of a packet may also depend on the detected gap between the packet and the preceding packet.

In addition to the elements described above, the flow of documents through the image entry feeder module 110 may also be controlled based on signals received from sensors in the imaging station 210. For instance, the imaging station 210 may include a feeder exit sensor 215 positioned downstream from the feeder 160, but upstream of crusher rollers 220 that engage the documents to control the transport of the documents through the imaging station 210. The feeder exit sensor 215 may be any of a variety of sensors that are operable to detect the leading and/or trailing edge of a document. In the present instance, the image entry sensor 215 is an infrared transmitter/receiver sensor.

As discussed above, when processing a packet, the system detects whether the transaction is a packet or a single document. If the transaction is a packet of documents, the system evaluates a measurement of the packet thickness. The packet is then advanced until the leading edge of the packet is positioned at the appropriate location relative to the feeder. Specifically, the leading edge of the packet is advanced into the feeder entry slot. The distance that the packet advances into the feeder entry slot may determined based in part on the packet thickness. Once the leading edge of the packet is advanced to the desired position in the feeder, one or both of the pre-feeders is disengaged. As discussed above, each pre-feeder is controlled by a separate clutch 185, 197 so that they pre-feeders can be independently engaged and disengaged.

By way of example, if the leading edge of the packet blocks the third sensor 190 c, the first clutch may be disengaged to disengage the drive force provided to drive roller 128 of the first pre-feeder. However, the second pre-feeder may remain actuated to urge the top document in the packet toward the feeder. The feeder 160 will continue to serially feed documents from the packet as long as the downstream documents continue to advance.

If the leading edge of the packet covers the fourth feeder sensor 190 d, the second clutch 197 may be disengaged to disengage the drive force provided by the drive roller 142 of the second pre-feeder. The feeder 160 may continue to serially feed documents from the packet as long as the downstream documents continue to advance. If there is an insufficient gap between the leading edge of the top document in the packet and the trailing edge of the preceding document, the drive motor may be turned off so that the feeder does not feed further documents from the stack. When the preceding piece advances sufficiently, the motor is re-started, but only the feeder is actuated; both pre-feeders remain disengaged. The second pre-feeder may be re-engaged once the third feeder sensor 190 c is no longer covered by the leading edge of the packet. Additionally, once the feeder 160 feeds a sufficient number of documents from the packet that the first feeder sensor 190 a is uncovered, the first clutch may be re-actuated to re-engage the first pre-feeder 122 so that both pre-feeders drive the packet toward the feeder as described previously. This process can iteratively proceed until the feeder feeds all of the documents in the packet, at which time the next packet is advanced.

Additionally, the imaging station 210 may include a sensor that detects the leading edge of documents downstream from the crusher roller prior to the documents entering the imager. At this point, the documents are entrained by the crusher roller 220 and no longer controlled by the image entry feeder module 110. The sensor may also be operable to detect the thickness profile of a document. The thickness profile can then be evaluated to determine a characteristic about the document. For instance, the profile for two documents as detected by the ultrasound sensor 155 is similar to the profile for an envelope. However, the thickness profile for an envelope has characteristics that distinguish the envelope from two sheets of paper due to the changes in thickness over the length of the envelope resulting from the seams of the envelope.

Configured as described above, the image entry feeder module 110 operates as follows. The drop conveyor 100 conveys one or more documents to the image entry feeder module 110 to feed the document(s) to the imaging station 210. If the document(s) is creased or otherwise sticking up from the drop transport 100, the entry guide 115 deflects the document(s) toward the first pre-feed assembly 124. The document(s) enter the nip between the drive roller 128 and the driven roller 130. As the documents enter the nip, the drive roller or upper roller 128 is displaced away from the lower driven roller 130 to provide clearance of the document(s). A thickness detector detects the displacement of the pivot arm 130 as the upper roller moves away when the documents enter the nip of the first pre-feed assembly. Alternatively, rather than thickness detector, a signal from ultrasonic detector 155 indicative of a thick packet of documents may be used. The signal from the thickness detector or ultrasonic detector is communicated with the central controller, and if the thickness detected exceeds a predetermined threshold, then the packet is considered a thick packet, and the drop conveyor 100 is stopped until the thick packet has been fed to the imaging station by the image entry feeder module 110. Specifically, the system does not advance documents into the first pre-feed assembly 122 until the document(s) being fed from the second pre-feed assembly 124 to the feeder 160 are finished being fed. For instance, if the feeder 160 is feeding a packet of five documents to the imaging station 210, it is desirable to maintain the grouping of the packet, without mixing the documents in the packet with other documents. Therefore, no further documents are advanced into the second prefeed assembly while that feeder 160 is finishing singulating the documents in the packet. Once the final document in a packet clears the second pre-feed assembly, the system sends a signal to the document transport to advance the next document or packet of documents from the drop feeder 100 to the pre-feed assembly 120.

The image entry feeder 110 module processes single document differently than a packet. Specifically, as the single document passes the ultrasonic thickness detector 155 the detector determines whether the transaction is a single document or a packet. If the detector 155 determines that the transaction is a single document, the document continues through the second pre-feed roller without stopping.

In contrast to the example of a single document, when a packet of documents is fed to the pre-feeders, the ultrasound detector 155 detects a transaction profile that is indicative of a packet rather than an individual document. In response to a signal from the system that the transaction is a packet, the brake may be energized. Specifically, once the transaction is determined to be a packet, the brake may be energized a predetermined time delay after the time that the leading edge of the packet is detected by the pre-feed sensor. However, it may be desirable to energize the brake for each transaction regardless of the whether the transaction is a single document or multiple documents.

The timing of braking is independent from the timing of the determination that the transaction is a packet. In other words, the timing of the brake is not measured from the time that the system determines that the transaction is a packet. In fact, in typical operation, the pre-feed sensor may detect the leading edge of a transaction before the system determines whether or not the transaction is a packet in response to the signals from the ultrasound detector 155. Nonetheless, once the determination is made, the timing of the brake actuation is measured from the time that the leading edge passed the pre-feed sensor.

Since the brake is connected to the drive shafts for the lower rollers of pre-feeders 122, 140, actuating the brake impedes displacement of the lower rollers of the pre-feeders 122, 140. By braking the lower rollers and continuing to drive the upper rollers to drive the packet forward, the top documents in the packet are shifted forwardly relative to the lower documents. In this way, the upper rollers tend to shift the documents in the packet forwardly relative to the bottom documents, causing the packet to shingle so that the leading edge of the top document overhangs the lead edge of the second document in the packet, which overhangs the lead edge of the third document in the packet, and so on, down to the bottom document in the packet. Shifting the top document(s) forwardly facilitates improved singulation of the packet relative to a packet in which the top document in a packet is disposed rearwardly of the documents below in the packet.

Once the top document in a packet enters the feeder 160, the feeder belts 165 drive the document through the feeder toward the imaging station 210. In this way, the feeder separates the lead document from the remaining documents in the packet, thereby singulating the document. As the leading edge of the document leaves the feeder 160, the feeder exit sensor 215 senses the leading edge of the document. In response, the pre-feed clutch 197 may disengage the driving force transmitted to the upper pre-feed rollers via the pre-feed drive belts 198, 199. Disengaging the pre-feed upper rollers, reduces the tendency of the rollers to buckle the documents, which can occur in response to driving the packet forward toward the feeder while the retard holds the documents back.

After the lead document passes the feeder exit sensor 215, the leading edge of the document enters the nip formed between the crusher rollers 220. The crusher rollers 220 positively entrain the document and have greater frictional control over the document than the frictional force between the feeder 160 and the document. Therefore, the feeder 160 does not need to drive the document forwardly in order to continue to advance the document. Accordingly, once the leading edge of the document is detected by the sensor downstream from the crusher rollers 220, such as the thickness detector (or a separate sensor detector similar to the feeder exit sensor 215), it is known that the document is entrained by and therefore controlled by the crusher rollers. Therefore, to reduce the likelihood of the feeder 160 feeding the second document in the packet before the first document is completely fed (commonly referred to as a double-feed), the controller may turn off the drive motor, thereby stopping the feeder 160. Despite the fact that the feeder is stopped, the crusher rollers 210 entrain the document with sufficient frictional force that the crusher rollers drive the document forwardly, pulling it out of the feeder. A one-way overrun clutch allows the belt roller to spin while the feeder motor is stopped while the crusher rollers pull the document out. Once the feeder exit sensor 215 senses the trailing edge of the document, the controller then actuates the drive motor 125-3 to re-start the feeder to feed the next document in the packet in the same way that the previous document was fed. Additionally, the clutch 197 is actuated to re-connect the pre-feed drive belts 198, 199 with the motor 125-3, so that the upper rollers of the pre-feed assemblies 122, 140 urge the packet toward the feeder 160.

### Imaging Station

From the image entry feeder module 110, the documents serially enter a nip formed between a pair of crusher rollers 220. Although the entry feeder holds the documents down, it does not flatten the documents; it generally just holds an edge of the document flat against the base plate of the feeder. In contrast, the crusher attempts to flatten the creased documents.

The crusher rollers 220 are elongated cylindrical aluminum rollers 222 having a smooth surface. A plurality of elastomeric gripping rings 224 are formed around the circumference of the roller 222, and spaced apart from one another. Preferably, a first gripping ring is positioned at the end of the roller 224 closest to the entry feeder 110, and a second gripping ring is positioned on the roller a couple inches away. More specifically, preferably the second gripping ring is spaced inwardly less than the width of the feeder 110. In addition, preferably a third gripping ring is positioned adjacent the opposite end of the roller. The first and second gripping rings 224 provide nips that drive the paper from the entry feeder to the imager 230. The third gripping rings are positioned so that they are not in the paper path (i.e. the third gripping rings do not engage the documents. Instead, the third gripping rings provide spacing to maintain the rollers parallel with a constant gap.

Preferably, the first two gripping rings 224 on the rollers 222 are positioned so that both rollers engage a single fold for documents that are tri-folded with the fold lines disposed parallel to the paper path. In this way, the gripping rings engage the edge-justified third of the tri-folded document, while the rest of the document can slide across the width of the crusher roller since the remaining width of the crusher roller in the paper path is aluminum. In this way, the crusher roller flattens the documents without buckling the documents.

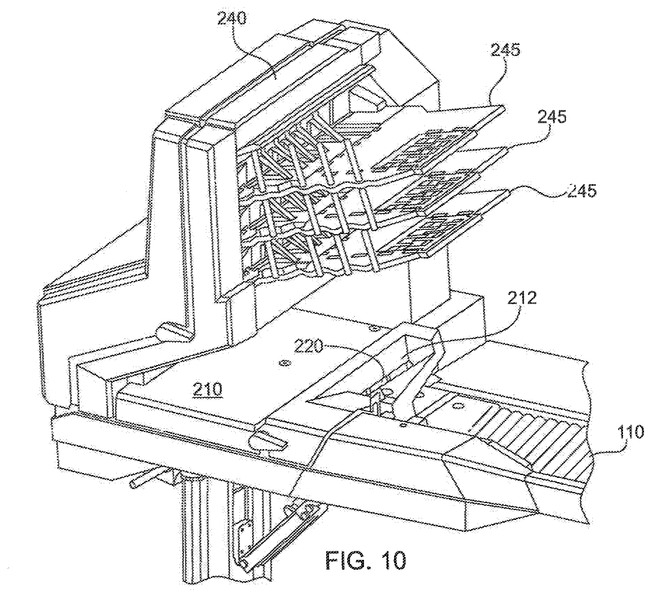

Referring now to FIGS. 9-10, a crusher slot 212 is provided. As discussed above, the feeder 160 feeds documents to the crusher roller 220. A cover 214 covers the document path. The cover 214 is spaced off of the base plate of the machine so that the feeder pulls the documents under the cover and through the gap to feed the documents to the crusher rollers 220. As discussed previously, the documents are in a horizontal relationship as the feeder 160 drives the documents toward the crusher rollers 220.

The crusher slot 212 is formed in the cover 214 adjacent the crusher rollers 220. Specifically, the crusher slot 212 extends through the cover 214 to direct documents to the nip of the crusher rollers 220. The crusher slot extends into the gap between the cover 214 and the base plate of the paper path. In this way, the crusher slot is disposed immediately downstream from the feeder 160. Documents can be dropped into the crusher slot 212 and an angled ramp in the crusher slot will direct the leading edge of the document into the nip of the crusher rollers so that the document is pulled into a substantially horizontal orientation so that the document can be processed through the imager 230 and then sorted by the sorting station 240.

A plurality of feeder exit sensors are disposed in the feeder between the image entry feeder module 110 and the crusher roller 220. After passing the feeder exit sensors and the crusher roller 220, the document passes through a thickness detector that measures the document at a plurality of points along the length of the document.

From the thickness detector, the document enters the imager 230. Preferably the imager comprises a pair of scanners for scanning both sides of the document. Specifically, preferably the imager 230 includes a lower plate in which the lower scanner 230 is located, and an upper plate in which the upper scanner is located. The lower scanner 230 scans the bottom face of the document, and the upper scanner scans the upper face of the document. As shown in FIG. 4 preferably the upper plate of the scanner is pivotable upwardly away from the lower plate to allow access into the imaging station 210 in the event of a jam in the imaging station.

Although the scanners may be black and white or gray scale, preferably, the scanners 230 are color scanners. More specifically, preferably the scanners 230 are contact image sensor (CIS) modules formed of arrays of photodiodes that operate as scanning elements, and LED light sources.

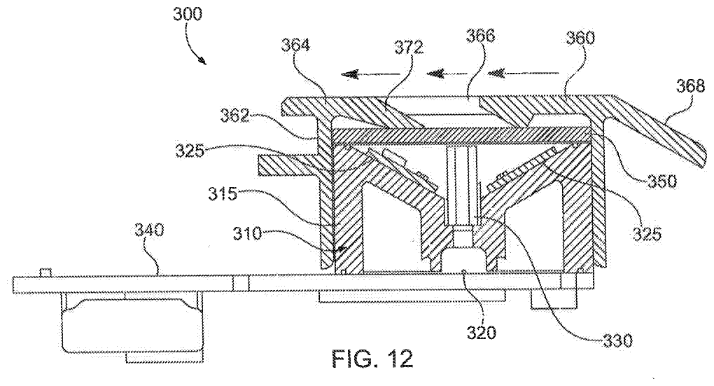

Referring to FIG. 12, details of an imaging assembly 300 are illustrated. The imaging assembly 300 may be incorporated into the imager 230 of the imaging station 210.

The imaging assembly 300 comprises an elongated housing 310 that extends across the width of the document path. The housing 310 is shaped similar to an elongated channel having side walls 315. It should be noted that FIG. 12 is a cross-sectional view along the length of the channel. A central slot in the base of the housing forms a socket into which the imaging sensor 320 is positioned. It should be understood that the imaging sensor comprises a series of elements extending along the length of the channel so that the imaging sensor is able to obtain image data along the width of the paper path.

A pair of angled shoulders in the housing provide support surfaces onto which illumination elements are mounted. For instance, LED arrays 325 are mounted onto the angled shoulders to illuminate the documents as the documents are conveyed over the imaging assembly 300. A lens 330 may be positioned over the imaging sensor 320. For instance, in the present instance, a focusing rod lens array is provided. The imaging sensor is in electrical communication with the contact image sensor PCB circuit.

A glass covering or lens 350 encloses the upper end of the housing 310. In the present instance, the glass 350 is a generally planar element forming a flat plate. The light elements 325 are disposed at angle to the surface of the glass, while the imaging sensor 320 is substantially perpendicular to the glass covering.

A cap 360 overlies the glass covering 350. The cap 369 comprises an elongated channel formed of two spaced apart legs 362. The legs 362 are spaced apart a distance corresponding to the width of the imaging housing 310 so that the cap can clip onto the housing to fix the position and orientation of the cap relative to the housing, which in turn fixes the position of the cap relative to the imaging sensor 320.

The cap 360 further includes a top face 364 that overlies the glass lens 320. A slot 366 through the thickness of the top face of the cap provides an aperture through which the imaging sensor can obtain image data for the documents to be scanned. As shown by the arrow in FIG. 12 extending from right to left, the arrow indicates the direction of travel for the documents as the documents pass over the imaging assembly 300. A tapered surface or ramp 368 guides the documents onto the top surface 364 of the cap 360 as the documents pass over the imaging assembly. Additionally, the trailing edge of the slot 366 in the cap 360 tends to direct the document along the paper path when the leading edge spans the slot 364. More specifically, the tapered lip 372 impedes the leading edge from curling down into the slot and potentially buckling down into the slot.

The top surface of the cap 364 forms the focal plane for the imaging sensor 320. However, the top surface of the cap is spaced apart from the glass and dust will tend to settle onto the glass. Since the upper surface of the cap is the focal plane and since the upper surface is spaced apart from the glass by a gap, the dust is outside of the depth of view of the imaging sensors. Therefore, the duct will have reduced impact, if any impact at all, on the image quality.

As the document passes between the scanners, the scanners scan the faces of the document to obtain image data representing a color image of the document faces. The image is communicated with the system computer and the image data is stored in a data file associated with the document.

From the scanner, the document is conveyed to a MICR detector, which attempts to read any MICR markings on the document. Specifically, MICR markings are printed in magnetizable ink. The MICR detector includes a magnet that exposes the document to a magnetic field. The MICR detector also includes a MICR reader that scans the document for magnetic fluctuations indicative of MICR characters. If the apparatus detects the presence of a MICR line, the MICR detector attempts to read the MICR line. The data representing the MICR information is then communicated with the system computer, which stores the MICR data in a data file associated with the document.

### Imaging Transport

The imaging transport extends between the imaging station 210 and the sorting station 240. Preferably the imaging transport is formed of two halves, and the upper half is pivotable away from the lower half to provide access to the transport path to remove any paper jam in the transport, or perform service on the interior element, as shown in FIG. 4.

As shown in FIG. 1, the document path between the imaging station 210 and the sorting station 240 is preferably not a straight horizontal path. Instead, preferably, the imaging transport turns upwardly and curves backwardly toward the seating area 15. Between the imaging station 210 and the sorting station 240, an optional uncreasing station and a printer may be disposed along the transport path. The uncreasing station is a guide having a sharp edge that the documents pass over as the documents turn along the transport path. If included, the printer is disposed along the transport so that the printer can print markings on the documents as they are conveyed to the sorting station 240.

The printer includes at least one ink jet printer. The printer is disposed behind covers in the imaging transport. More specifically, a first printer is preferably disposed behind a plate in the upper portion and preferably the second printer is disposed behind a plate in the lower portion. In response to signals from the computer, the printer(s) prints audit trail data onto each document. The audit trail information printed on a document includes data particular to the document, such as the document type for each document, the batch number for the document, the document number, the transaction number for the transaction of which the document is a member, and the date on which the document was processed. The audit trail information can be used to subsequently locate a particular document within a stack of documents.

### Sorting Station

The sorting station 240 is disposed at the end of the imaging transport, and the sorting station includes a plurality of gates operable to sort the documents into one of a plurality of bins 245. The sorting station includes a plurality of gates that are operable to direct the documents to the appropriate bin 245. The sorting can be based on a number of criteria. For instance, the documents can be sorted according to information determined from the image data.

The documents follow a generally vertical paper path as the documents are conveyed up to the output bins 245. When the documents are directed into one of the bins, the gate re-directs the document from a generally vertical direction headed upward to a generally horizontal path over a series of output rollers 252 mounted on a rotatable axle 250. The document is the directed generally downwardly toward the output bin 245. In this way, the documents curl over the output rollers 252. As such, the leading edge of the document frequently tends to buckle under when it contacts the bottom of the output bin or the other documents in the output bin. When the documents buckle under the document fold and often deflect subsequent preventing the documents from forming a neat and compact stack in the output bin.

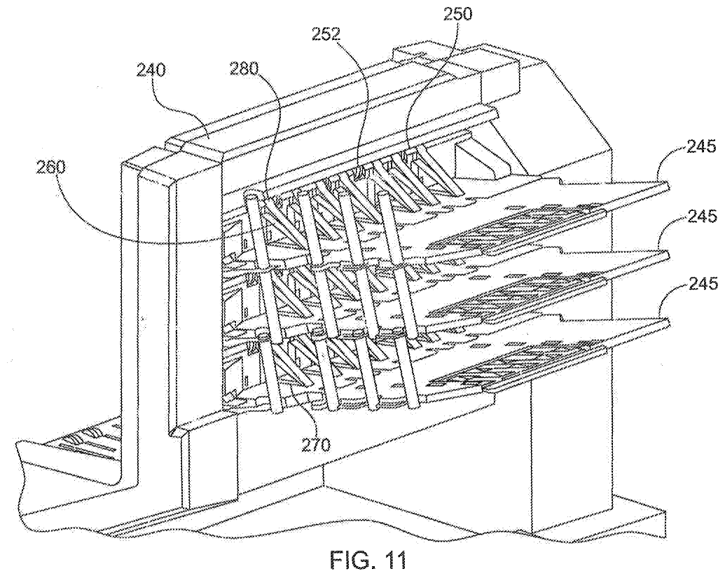

Referring to FIG. 11, in the present instance, a pair of guide elements may be provided to guide the documents into the output bin and impede the document from buckling under. Specifically, a plurality of support fingers 260 are spaced apart across the width of the output bin. The guide finger 260 form guide ramps that guide the leading edge of the documents down toward the output bin at a relatively shallow angle to prevent the lead edge from buckling under.

Each support finger 260 has a proximal end mounted adjacent the discharge slot through which the document is discharge into the output bin. The distal end of each support finger extend downwardly into a guide slot 270 formed in the base of the output bin 245. In the present instance the distal end of the support fingers form an oblique angle with the base of the output bin to impede the document from buckling under.

Additionally, a plurality of hold down fingers 280 oppose the support fingers to form a slot through which the documents are discharged. Specifically, the proximal ends of the support fingers 260 are spaced apart to provide and opening through which the documents are discharged. The support fingers support the lower face of the documents to keep the document from buckling under while the hold down fingers press against the top surface of the document impeding the document from curling upwardly. The distal end of the hold down fingers 280 rest against the support fingers when the output bin is empty or against the top document when there is a document in the output bin. Additionally, the upper or proximal end of each hold down finger 280 is pivotally connected to a support rod adjacent the discharge rollers 252. In this way, as the pile in the bin grows, the distal end of the hold down fingers are pushed upwardly and supported by the stack.

In order to promote the flow of documents into the bin, the support fingers are pressed downwardly from the weight of the documents in the bin. Specifically, as noted above, the proximal end of the hold down fingers hang from a support adjacent the discharge slot for the bin. A gap is formed between the support fingers 260 and the hold down fingers 280. In order to maintain the gap to accommodate documents being discharged into the bin, the proximal end of the support fingers move downwardly away from the proximal end of the hold down fingers 280 as more documents are sorted to the output bin.

The proximal ends of the support fingers 260 may be mounted on a horizontal rod that extends across the width of the output bin. The horizontal rod may be vertically displaceable in response to the weight of the documents pressing down against the support fingers. More specifically, one or more biasing elements may bias the horizontal support rod upwardly. As documents are discharged into the output bin 245, the weight of the documents pushes down against the support fingers 260, which in turn will tend to displace the support rod downwardly against the bias of the biasing elements.

Alternatively, rather than mounting the support fingers on a common horizontal support rod, the fingers may be independently mounted on a guide that allows the proximal end of the support fingers to be displaced vertically. Each finger may also be biased upwardly to provide the upwardly force that will support the support fingers while allowing the support fingers to move downwardly in response to an increasing weight of the stack of documents.

When configured as described above, the displaceable support fingers provide a generally constant shallow discharge angle for the documents as the documents enter the output bin. Specifically, as the documents stack up in the bin, the support fingers move downwardly so that the position of the top documents in the output bin relative to the hold down fingers stays relatively constant as documents stack up in the bin.

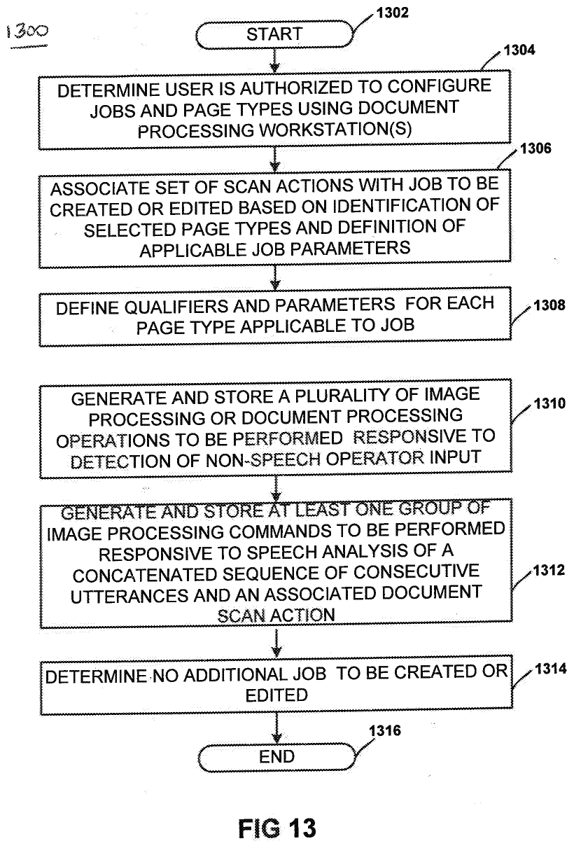

FIG. 13 is a flow chart depicting a job or transaction set up process 1300 as may be performed by a manager or administrator according to embodiments which may be implemented, for example, using a document processing workstation according to FIG. 1 or FIG. 2. The process 1300 is entered at 1302 and proceeds to 1304 where process 1300 determines that a user is a party (e.g., a manager or administrator knowledgeable about the needs of a specific organization and the capabilities of the document processing workstation being used to implement process 1300. From 1304, process 1300 proceeds to 1306.

At 1306, process 1300 associates a set of document processing (e.g., document handling and/or document scan) actions associated with a job or transaction to be created or edited based, for example, on identification of a page type that is part of a constellation of available page types and definitions of applicable job parameters. From 1306, process 1300 proceeds to 1308, where process 300 defines qualifiers and parameters for each page type of a constellation of page types. From 1308, process 1300 proceeds to 1310.

At 1310, process 1300 generates and stores a plurality of image processing or document processing operations to be performed responsive to detection of non-speech operator input and proceeds from 1310 to 1312 where process 1300 generates and stores at least one group of image processing commands to be performed responsive to a state-aware speech analysis of a concatenated sequence of words or phrases contained in an operator utterance. From 1312, process 1300 proceeds to 1314 where process 1300 determines that no additional job is to be created or edited and, at 1316, process 1300 terminates.

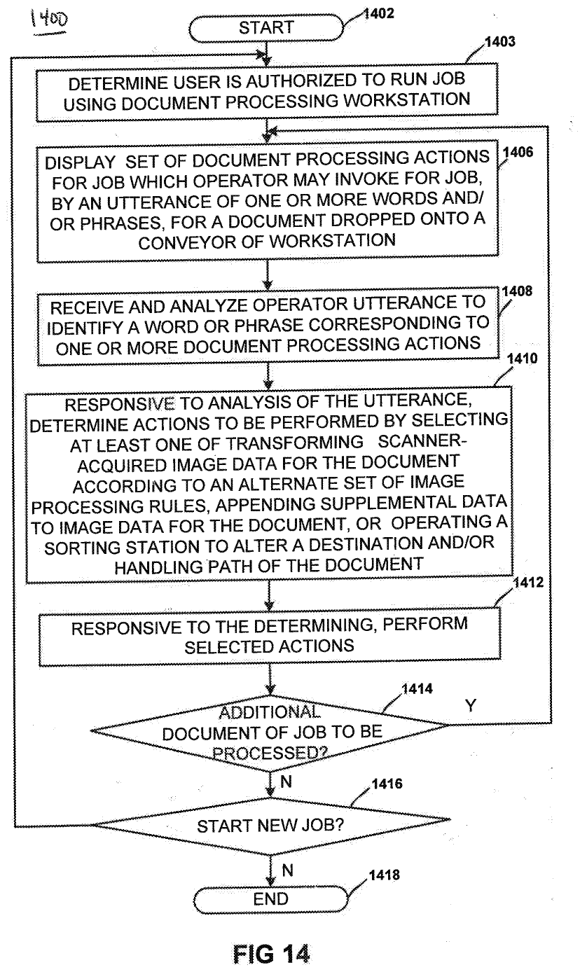

FIG. 14 is a flow chart depicting an exemplary process 1400 for operating a document processing work station utilizing speech analysis to identify concatenated words and/or phrases to dynamically implement appropriate sets of document handling and/or image processing rules according to embodiments consistent with the present disclosure, the steps of which may be performed using a document processing workstation according to FIG. 1 or FIG. 2.

Process 1400 is entered at 1402 and proceeds to 1403 where process 1400 determines that the user is authorized to run a job using the document processing work station. From 1403, process 1400 proceeds to 1406, where process 1400 displays a set of document processing actions for a job which operator may invoke for the job by utterance of one or more words and/or phrases and dropping a document onto the workstation. From 1406, process 1400 proceeds to 1408.

At 1408, process 1400 receives and analyzes operator utterances to identify a word or phrase corresponding to one or more document processing actions. From 1408, process 1400 proceeds to 1410 where responsive to analysis of the utterance process 1400 determines actions to be performed and, from 1410, proceeds to 1412 where process 1400 performs the selected actions. From 1412, process 1400 proceeds to 1414 where, if a determination is made that there are additional documents to be acted upon for the current job by process 1400 (e.g., by sensing a document dropped onto a drop conveyor), the process 1400 returns to 1406. If at 1414, no such determination is made, the process 1400 proceeds to 1416 and determines if a new job is to be started. If so, the process 1400 returns to 1403 and, if not, the process 1400 proceeds to 1418 an terminates.

What is claimed is:

1. A method for processing documents, comprising the steps of:
placing a document onto a document transport of a document processing workstation;
conveying the document along the document transport to a scanner of the document processing workstation;
performing speech analysis upon one or more utterances made by an operator of the document processing workstation;
scanning the document to acquire a set of image data corresponding to an image of the document;
displaying, at the document processing workstation, an image of the document;
based on the performed speech analysis, selecting and performing at least one document processing action by
storing supplemental information, determined by speech analysis to be specified by an utterance of the one or more utterances, in association with the acquired set of image data,
analyzing the acquired set of image data, responsive to a determination of document type obtained by speech analysis of an utterance of the one or more utterances, to obtain supplemental information and storing the obtained supplemental information in association with the acquired set of image data,
determining that an utterance of the one or more utterances includes an instruction to perform an image altering action as the at least one document processing action and, responsive to determination of an image altering instruction, generating and storing a modified set of image data, wherein the displaying includes displaying a modified image at the workstation based on the modified set of image data, and/or
determining that an utterance of the one or more utterances includes an instruction necessitating transformation of the acquired image data according to a predefined alternate set of one or more image processing rules that deviate from a default set of one or more rules predefined for documents possessing a predetermined attribute common to the document scanned, whereby a displayed document obtained by application of the alternate set of one or more image processing rules differs visually from a displayed document obtained by application of the default set of one or more image processing rules.

2. The method of claim 1, wherein performing the speech analysis includes determining that an utterance of the one or more utterances communicates at least one of a characterizing feature of the document, a type classification of the document, and/or an output destination of the document.

3. The method of claim 2, wherein responsive to a determination that an utterance of the one or more utterances identifies a document type having two sides to be scanned, the at least one document processing action further includes scanning both sides of the document to acquire first and second sets of image data, respectively.

4. The method of claim 2, wherein responsive to a determination that an utterance of the one or more utterances identifies a first document type, the at least one document processing action further includes conveying the scanned document along a folded discharge path terminating at a first destination and wherein responsive to a determination that an utterance of the one or more utterances identifies another document type, the at least one document processing action includes conveying the scanned document along a folded discharge path terminating at a second destination.

5. The method of claim 2,
wherein the scanner is configured to acquire a set of image data from which a multichromatic representation of the document could be displayed and stored, and by default to convert and store the acquired set of image data to a format suitable for rendering black and white or for grey scale images, but absent a contrary instruction, not color; and
wherein responsive to a determination that an utterance of the one or more utterances identifies the document as a multichromatic document, performing the at least one selected document processing action includes storing a deviating set of image data representative of a color image and displaying the color image.

6. The method of claim 2, wherein responsive to a determination that the utterance identifies the document as being one of a check, a prescription form, a claim form, an application form, an affidavit, or an invoice, and wherein the at least one selected document processing action includes performing optical character recognition to identify predetermined fields of the document.

7. The method of claim 1, wherein the selecting includes determining that the utterance comprises a concatenated series of discrete words and/or phrases,
determining that a correspondence exists between a first uttered word or phrase and a first predefined set of one or more document processing actions,
determining that a correspondence exists between a second uttered word or phrase and a second predefined set of one or more document processing actions, and
performing the first and second sets of document processing actions.

8. The method of claim 7, wherein performing the first set of one or more document processing actions includes
determining that the first uttered word or phrase requires performance of a first image altering action and
generating and storing a modified set of image data from the acquired set of image data; and
wherein performing the second set of document processing actions includes analyzing the acquired set of image data to obtain supplemental information and storing the obtained supplemental information in association with the modified set of image data.

9. The method of claim 8, wherein the first image altering action comprises transforming the acquired set of image data to obtain a modified set of image data for representation of an image rotated by one of ninety, one hundred and eighty, or two hundred and seventy degrees 10. The method of claim 7, wherein performing the first set of one or more document processing actions includes
determining that the first uttered word or phrase requires determining that the first uttered word or phrase includes an instruction necessitating transformation of the acquired image data according to a predefined alternate set of one or more image processing rules that deviate from a default set of one or more rules predefined for documents possessing a predetermined attribute common to the document scanned, whereby a displayed document obtained by application of the alternate set of one or more image processing rules differs visually from a displayed document obtained by application of the default set of one or more image processing rules, and
transforming the acquired image data, according to the predefined alternate set of one or more image processing rules, to obtain a transformed; and
wherein performing the second set of document processing actions includes storing, in association with the image data acquired according to the predefined alternate set of one or more image processing rules, supplemental information obtained by at least one of speech analysis of the second uttered word or phrase or by analyzing the acquired set of image data to obtain supplemental information.

11. The method of claim 10, wherein application of the default set of one or more image processing rules results in transformation, of an image captured in color by the scanner, to a set of image data corresponding to a grey scale or black and white image, wherein responsive to a determination that the second uttered word or phrase specifies a color image, the image data transformed during the transforming preserves multichromatic properties of the acquired set of image data.

12. A document processing workstation, comprising:
a scanner configured to acquire a set of image data by scanning a document;
a document transport defining a document receiving surface and being configured to convey and feed, to the scanner, a document to be scanned;
a display; and
a controller comprising
a processor;
a memory containing instructions executable by the processor,
to perform speech analysis upon utterances made by an operator of the document processing workstation;
to initiate acquisition, by the scanner, of a set of image data corresponding to an image of a scanned document;
to select, based on the performed speech analysis, at least one document processing action based on information derived from an utterance; and
to perform the at least one selected document processing action by at least one of
storing supplemental information, determined by speech analysis of the utterance, in association with the acquired set of image data or with a modified set of image data based on the acquired set of image data,
analyzing the acquired set of image data to obtain supplemental information and storing the obtained supplemental information in association with the acquired set of image data or with a modified set of image data,
generating and storing a modified set of image data, wherein the displaying includes displaying a modified image at the workstation based on the modified set of image data, or
determining that the utterance includes an instruction necessitating transformation of the acquired image data according to an alternate set of one or more image processing rules contained in memory, the memory further containing a default set of one or more image processing rules according to which transformation of image data acquired from a document having similar image attributes would be implemented absent the determining.

13. The document processing workstation of claim 12, wherein the memory further contains instructions executable by the processor to perform the selecting by, responsive to analysis of an utterance, determining that a plurality of imaging processing actions is to be performed to modify the acquired set of image data.

14. The document processing workstation of claim 13, wherein the utterance comprises a concatenated series of discrete words and/or phrases for which respective image processing instructions are stored in the memory, and wherein the memory further contains instructions executable by the processor to identify and execute discrete image processing commands associated with the utterance.

15. The document processing workstation of claim 13, wherein the memory further contains instructions executable by the processor to perform the determining by identifying the plurality of discrete words or phrases by reference to speech analysis results and to a group of image processing actions associated in memory with a document type.

16. The document processing workstation of claim 15, wherein the memory further contains a default set of one or more rules comprising an image processing step executable by the processor to omit an attribute when transforming respective sets of image data, respectively acquired by scanning; and
an alternate set of one or more rules comprising an image processing step executable by the processor to preserve the attribute when transforming acquired image data for a scanned document possessing the attribute, the memory further containing instructions executable by the processor to implement the default set of rules before storing a scanned document absent an utterance corresponding to an instruction to preserve the attribute before storing the scanned document.

17. The document processing workstation of claim 16, wherein the default set of one or more rules comprises storing a set of image data which omits all colors but white, black, or shades of grey.

18. The document processing workstation of claim 12, wherein the memory further contains instructions executable by the processor to determine that the utterance communicates at least one of a characterizing feature of the document, a type classification of the document, or an output destination of the document.

19. The document processing workstation of claim 18, wherein the memory further contains instructions executable by the processor to determine, by speech analysis, that an utterance identifies the document as being one of a check, a prescription form, a claim form, an application form, an affidavit, or an invoice, and for performing optical character recognition to identify and store information located at specific locations of the document.

20. The document processing workstation of claim 19, wherein the memory further contains instructions executable, responsive to a determination that the utterance identifies a document type having two sides to be scanned, to operate the scanner to scan both sides of the document to acquire first and second sets of image data, respectively.

21. The document processing workstation of claim 19, wherein the memory further contains instructions executable, responsive to a determination that the utterance identifies a first document type, to operate a discharge assistant of the scanner to convey the scanned document along a folded discharge path terminating at a first destination and wherein responsive to a determination that the utterance identifies another document type, to operate a discharge assistant of the scanner to convey the scanned document along a folded discharge path terminating at a second destination.
